(19) United States
(12) Patent Application Publication
(10) Pub. No.: US 2010/0252185 A1
(43) Pub. Date: Oct. 7, 2010

(54) REMOVABLE PRESSURE SENSITIVE ADHESIVE SHEET AND METHOD FOR PROCESSING ADHEREND USING THE SAME

(75) Inventors: Kazuyuki Kiuchi, Osaka (JP); Akinori Nishio, Osaka (JP)

Correspondence Address: SUGHRUE-265550, 2100 PENNSYLVANIA AVE. NW, WASHINGTON, DC, 20037-3213, US

(73) Assignee: NITTO DENKO CORPORATION, Osaka (JP)

(21) Appl. No.: 12/754,858

(22) Filed: Apr. 6, 2010

(30) Foreign Application Priority Data
Apr. 7, 2009 (JP) 2009-092664

(51) Int. Cl. B32B 38/10; C09J 7/02; C09J 5/06

(52) U.S. Cl. 156/247; 428/40.1

(57) ABSTRACT

The present invention provides a removable pressure sensitive adhesive sheet, which includes: a self-rolling pressure sensitive adhesive sheet which is capable of spontaneously rolling up by a thermal stimulation, the self-rolling pressure sensitive adhesive sheet including a first pressure sensitive adhesive layer, a first rigid film layer, an elastic layer and a heat contractible film layer laminated in this order; and a second pressure sensitive adhesive layer and a second rigid film layer laminated in this order on the heat contractible film layer side of the self-rolling pressure sensitive adhesive sheet, in which the second pressure sensitive adhesive layer is removable from the heat contractible film layer or the second rigid film layer is removable from the second pressure sensitive adhesive layer.

### FIELD OF THE INVENTION

This invention relates to a removable pressure sensitive adhesive sheet which can maintain the state of being attached to an adherend even after passing through a heating step and also can be easily removed the adherend upon heating, and to a method for processing an adherend using the same.

### BACKGROUND OF THE INVENTION

A semiconductor wafer made of silicon, germanium, gallium arsenide or the like as the material is produced in a state of large diameter and then subjected to a back grinding to a predetermined thickness and further subjected to a back treatment (etching, polishing or the like), cutting processing and the like as occasion demands, thereby producing a semiconductor chip. In recent years, demand for the thinning and lightening of semiconductor materials has been increasing more and more, and regarding a semiconductor wafer, it became necessary to thin down its thickness to 100 μm or less than that, but such a thin film wafer is very brittle and easy to break. Accordingly, at the time of a semiconductor wafer processing, there is a method being employed in which an appropriate processing is carried out while holding the semiconductor wafer with a pressure sensitive adhesive sheet for tentative fixing use and then the pressure sensitive adhesive sheet for tentative fixing use is removed and recovered from the semiconductor wafer.

Such a pressure sensitive adhesive sheet for tentative fixing use is generally composed of an energy ray curing pressure sensitive adhesive layer and is applied to, for example, a method in which the sheet is fixed to a wafer, a processing such as polishing, dicing or the like is applied to the tentatively fixed wafer and then the pressure sensitive adhesive layer is cured by an energy ray irradiation and the resulting pressure sensitive adhesive sheet having reduced adhesive strength is removed from the wafer. However, the pressure sensitive adhesive sheet having reduced adhesive strength caused by the energy ray irradiation is still adhered closely to the wafer surface by the atmospheric pressure. Accordingly, in order to remove the pressure sensitive adhesive sheet from the wafer, it requires an operation such as rolling up of the pressure sensitive adhesive sheet, but there is a problem in that the rim of the wafer is apt to be broken or damaged due to stress and the like at the time of such an operation. In addition, when thickness of the wafer becomes thin after its grinding (e.g., when it becomes a thinness of about 25 μm), edge part of the pressure sensitive adhesive sheet attached to the wafer sometimes protrudes to outer side than the wafer edge, which may poses a problem of causing a difficulty in its removal due to sticking of this protruded part to the pedestal surface of the operation or dicing tape or the like member arranged on the grinding face side of the wafer.

JP-A-2008-155619 describes that a self-rolling pressure sensitive adhesive sheet which spontaneously forms a rolled body upon heating, in which a heat contractible film layer, an elastic layer, a rigid film layer and a pressure sensitive adhesive layer are laminated in that order, is used as a pressure sensitive adhesive sheet for tentative fixing use. However, since rolling of the above-mentioned self-rolling pressure sensitive adhesive sheet depends on the heat contraction temperature of the heat contractible film layer, when a processing which includes a heating step is applied to an adherend, there is a case where the self-rolling pressure sensitive adhesive sheet is removed from the adherend during the processing depending on the processing condition so that it becomes difficult to prevent generation of “crack” or “chip” of the adherend. For example, in the case of PVD (physical vapor deposition), plasma etching and the like processing, it is known that a heat of about 70° C. or more is necessarily applied even by a heating step of the most lower temperature.

### SUMMARY OF THE INVENTION

Accordingly, an object of the invention is to provide a removable pressure sensitive adhesive sheet which is capable of preventing generation of “crack” or “chip” of an adherend even in case where the adherend is considerably brittle and a processing which includes a heating step is applied to the adherend and also can be removed easily from the adherend after processing of the adherend, and a method for processing an adherend using the removable pressure sensitive adhesive sheet.

With the aim of achieving the aforementioned object, the present inventors have conducted intensive studies and found as a result that when a removable pressure sensitive adhesive sheet, in which a pressure sensitive adhesive sheet having a specified structure is laminated on a heat contractible film layer side of a self-rolling pressure sensitive adhesive sheet including a pressure sensitive adhesive layer, a rigid film layer, an elastic layer and the heat contractible film layer, is used as a pressure sensitive adhesive sheet for a tentative fixing use or the like, heat resistance of the removable pressure sensitive adhesive sheet is improved so that the removable pressure sensitive adhesive sheet is not removed even when a processing which includes a heating step is applied to an adherend but can maintain its state of being stuck to the adherend, and after the processing, the removable pressure sensitive adhesive sheet can be easily separated and removed from the adherend by removing the aforementioned pressure sensitive adhesive sheet having a specified structure and subsequently carrying out heating. The invention has been accomplished by further carrying out studies based on these findings.

Namely, the present invention provides a removable pressure sensitive adhesive sheet, which includes:

a self-rolling pressure sensitive adhesive sheet which is capable of voluntarily rolling up by a thermal stimulation, the self-rolling pressure sensitive adhesive sheet including a first pressure sensitive adhesive layer, a first rigid film layer, an elastic layer and a heat contractible film layer laminated in this order; and

a second pressure sensitive adhesive layer and a second rigid film layer laminated in this order on the heat contractible film layer side of the self-rolling pressure sensitive adhesive sheet,

in which the second pressure sensitive adhesive layer is removable from the heat contractible film layer or the second rigid film layer is removable from the second pressure sensitive adhesive layer.

In the above-mentioned removable pressure sensitive adhesive sheet, a pressure sensitive adhesive sheet including a base material may be used as the second pressure sensitive adhesive layer and the second rigid film layer to be laminated on the heat contractible film layer side of the self-rolling pressure sensitive adhesive sheet.

In above-mentioned the removable pressure sensitive adhesive sheet, it is preferable that the second rigid film layer has a Young's modulus at 80° C. of from 1×10⁶ to 2×10¹⁰ Pa. Moreover, it is preferable that the second pressure sensitive adhesive layer has a shear modulus at 80° C. of 4×10⁴ Pa or more.

In addition, the present invention provides a method for processing an adherend, which includes steps of:

applying a certain processing to an adherend to which the above-mentioned removable pressure sensitive adhesive sheet has been attached;

then removing (1) the second pressure sensitive adhesive layer and the second rigid film layer or (2) the second rigid film layer of the removable pressure sensitive adhesive sheet; and

subsequently effecting rolling-separation of (1) the self-rolling pressure sensitive adhesive sheet or (2) the self-rolling pressure sensitive adhesive sheet and the second pressure sensitive adhesive layer, from the adherend by a heating treatment.

In the above-mentioned method, the processing step of the adherend may include a heating step conducted at 80° C. or more.

According to the invention, the removable pressure sensitive adhesive sheet has such a constitution that the pressure sensitive adhesive sheet having a specified structure is laminated on the heat contractible film layer side of the self-rolling pressure sensitive adhesive sheet, so that when this removable pressure sensitive adhesive sheet is used as a pressure sensitive adhesive sheet for tentative fixing use, surface protection use or the like, even when a processing which includes a heating step [e.g., spattering, deep reactive ion etching (DRIE) or the like] is applied to an adherend (work piece), the removable pressure sensitive adhesive sheet is not removed during the processing, and accordingly, even in the case of a very brittle adherend (e.g., an adherend having a thickness of approximately from 20 to 25 μm), generation of “crack”, “chip” and the like can be suppressed. In addition, the self-rolling pressure sensitive adhesive sheet spontaneously rolls up after processing of the adherend when the aforementioned pressure sensitive adhesive sheet having a specified structure or a part of the layer thereof is removed (e.g., by peeling) and a heating treatment is subsequently applied to the self-rolling pressure sensitive adhesive sheet sticking to the adherend, so that the self-rolling pressure sensitive adhesive sheet can be easily removed and recovered from the adherend without polluting or damaging the adherend.

### BRIEF DESCRIPTION OF THE DRAWINGS

FIG. 1 is a schematic sectional view showing an example of the removable pressure sensitive adhesive sheet of the invention.

FIGS. 2A to 2D are views (perspective illustration) showing a self-rolling condition of the self-rolling pressure sensitive adhesive sheet of the invention.

FIG. 3 is a schematic process drawing (sectional view) showing an example of the adherend processing method of the invention.

### DESCRIPTION OF REFERENCE NUMERALS AND SIGNS

1 Removable pressure sensitive adhesive sheet
2 Self-rolling pressure sensitive adhesive sheet
21 Heat contractible film layer
22 Elastic layer
23 First rigid film layer
24 First pressure sensitive adhesive layer
3 Pressure sensitive adhesive sheet layer
31 Second rigid film layer
32 Second pressure sensitive adhesive layer
4 Adherend (material to be processed)

### DETAILED DESCRIPTION OF THE INVENTION

The following describes embodiments of the invention in detail by referring to the drawings as occasion demands.

Removable Pressure Sensitive Adhesive Sheet

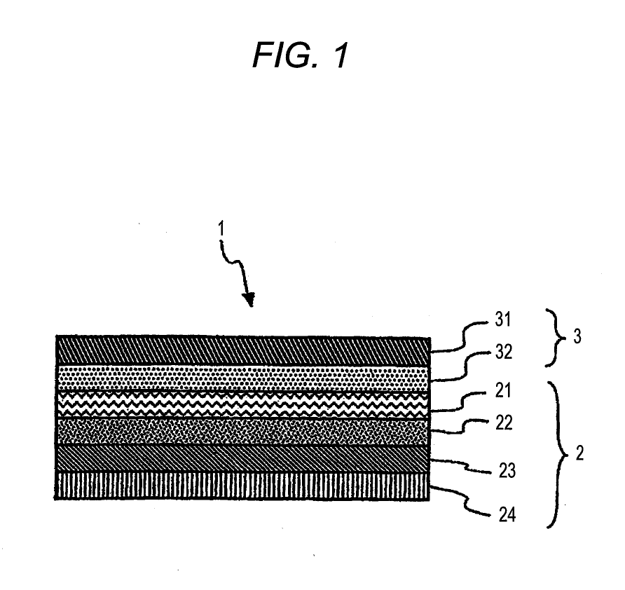

FIG. 1 is a schematic sectional view showing an example of the removable pressure sensitive adhesive sheet of the invention. In the removable pressure sensitive adhesive sheet 1 in this example, a first pressure, sensitive adhesive layer 24, a first rigid film layer 23, an elastic layer 22 and a heat contractible film layer 21 are laminated in that order and a second pressure sensitive adhesive layer 32 and a second rigid film layer 31 are further laminated in that order on the heat contractible film layer 21 side of a self-rolling pressure sensitive adhesive sheet 2 which is capable of spontaneously rolling up by a thermal stimulation, in which the removable pressure sensitive adhesive sheet is formed in such a manner that the second pressure sensitive adhesive layer 32 is removable from the heat contractible film layer 21 or the second rigid film layer 31 is removable from the second pressure sensitive adhesive layer 32. The removable pressure sensitive adhesive sheet may have a shape of tape. In this specification, laminate of the first rigid film layer 23 and elastic layer 22 may be referred to as “restriction layer” in some cases, and laminate of the second pressure sensitive adhesive layer 32 and second rigid film layer 31 may be referred to as simply “pressure sensitive adhesive sheet” or “pressure sensitive adhesive sheet layer”.

(Self-Rolling Pressure Sensitive Adhesive Sheet)

The self-rolling pressure sensitive adhesive sheet 2 is a sheet in which the first pressure sensitive adhesive layer 24, the first rigid film layer 23, the elastic layer 22 and the heat contractible film layer 21 are laminated in that order and which can perform rolling when a thermal stimulation is applied. The self-rolling pressure sensitive adhesive sheet 2 may be in the shape of a tape. In this connection, the term self-rolling means a property to spontaneously perform rolling after applying a thermal stimulation, without particular loading of an external force. Further, although it is desirable that the self-rolling pressure sensitive adhesive sheet 2 forms a cylindrical rolled body in which its both termini are overlapped to form a completely cylindrical rolling, it may not reach the completely cylindrical rolling without resulting in the overlapping of both termini, thus forming a cylindrical body having a shape in which a part of the side of the cylinder is opened in longitudinal direction. In addition, when the self-rolling pressure sensitive adhesive sheet 2 is separated and removed from an adherend using a peeling tape or the like after processing of the adherend, it may be effected by merely allowing the edge of the self-rolling pressure sensitive adhesive sheet 2 to float up from the adherend by controlling the heating.

(Heat Contractible Film Layer)

The heat contractible film layer 21 may be any film layer which shows contractibility upon heating and may be any one of a mono-axially contractible film, a bi-axially contractible film and the like. As the mono-axially contractible film, there may be used a mono-axially contractible film having a contractibility only in the mono-axial direction or there may be used a contractible film which has a main contractility in a certain direction (mono-axial direction) and a secondary contractibility in a direction different from said direction (e.g., a direction perpendicular to said direction). In addition, the heat contractible film layer 21 may be a single layer or a multiple layer composed of two or more layers.

Degree of contraction in the main contraction direction of the contractible film which constitutes the heat contractible film layer 21 is preferably from 30 to 90%, particularly preferably from 50 to 90%, at a predetermined temperature within the range of from 60 to 180° C. (e.g., 80° C.). In this connection, when bi-axially contracted at a predetermined temperature within the range of from 60 to 180° C. (e.g., 80° C.), an axial direction having higher degree of contraction is regarded as the main contraction direction. Heat contractibility of the contractible film can be provided by, for example, applying a stretching treatment to a film extruded by an extruder, in a mono-axial direction or bi-axial direction, and degree of contraction can be adjusted by the degree of its stretching.

As the mono-axially contractible film, a contractible film in which the degree of contraction in the direction other than the main contraction direction is less than 10% (preferably 5% or less, particularly preferably 3% or less) can be used. In the case of a mono-axially contractible film, when thermal stimulation is applied thereto, as will be described later, repulsion for shrinkage force of the heat contractible film layer 21 of the restriction layer becomes a driving force to cause floating of a peripheral region (one edge part or facing two edge parts) of the self-rolling pressure sensitive adhesive sheet 2, so that a cylindrical rolled body is formed by spontaneously rolling from the edge part either in one direction or in directions toward the center (generally, main contraction axis direction of the heat contractible film 21), with the heat contractible film layer 21 side rolling inward.

As the bi-axially contractible film, a contractible film in which the degree of contraction in the direction other than the main contraction direction is 10% or more [e.g., from 10 to 80%, preferably 15% or more (e.g., from 15 to 80%)] can be used. As the ratio of degree of contraction in the main contraction direction [A (%)] and degree of contraction in the direction perpendicular to the main contraction direction [B (%)], (A:B), from 1:1 to 10:1, particularly from 1:1 to 5:1, is desirable, and from 1:1 to 3:1 is particularly desirable. In the case of a bi-axially contractible film, the heat contractible film can be contracted by heating it from any direction, because it is considered that not only the perpendicular two directions but also, in reality, a contraction stress made by two contraction axes is synthesized and acts, so that the self-rolling pressure sensitive adhesive sheet 2 is spontaneously curved, with the heat contractible film layer 21 side rolling inward, to form a floating between the sheet and adherend and spontaneously rolled in one direction from one edge part when further heated.

When an active energy ray curing type pressure sensitive adhesive layer is used as the elastic layer 22 which connects the heat contractible film layer 21 and first rigid film layer 23 and as the first pressure sensitive adhesive layer 24 for sticking to an adherend, and when the active energy ray irradiation is carried out through the heat contractible film layer 21 at the same time, it is necessary that the heat contractible film layer 21 is constituted using a material which can permeate a predetermined quantity or more of active energy ray (e.g., a resin having transparency).

Suitably can be used as the heat contractible film which constitutes the heat contractible film layer 21 is, for example, a heat contractible film composed of one or two or more of resins selected from polymers having ultraviolet ray permeability, such as polypropylene, polyethylene and the like polyolefins; polyethylene terephthalate, polybutylene terephthalate, polylactic acid and the like polyesters; captan and the like polyimides; 6,6-nylon and the like polyamides; polyether sulfonic acids; polynorbornane; polyurethane; polystyrene; polyvinylidene chloride and the like.

As the heat contractible film, a mono-axially or bi-axially stretched film composed of a polyester type resin, a polyethylene, polypropylene, polynorbornane or the like polyolefin type resin (including a cyclic polyolefin type resin) or a polyurethane type resin is particularly desirable. These films have advantages in that they are excellent in the coating workability of pressure sensitive adhesive and in the cost and the like economical views and have high tackiness with the elastic layer to be used in its pasting with the rigid film layer which is described later, in addition to their the high response to the contraction initiation temperature.

Regarding thickness of the heat contractible film layer 21, it is generally from 5 to 300 μm, preferably from 10 to 100 μm. When the thickness is lower than 5 μm, operability becomes poor such as a difficulty in operating winding and feeding of film at the time of its production, and when the thickness exceeds 300 μm on the other hand, not only it is uneconomical but also the rigidity becomes so high that the spontaneous rolling becomes hard to occur. In addition, when the rigidity is high, elastic deformation strength by the stress at the time of attaching the self-rolling pressure sensitive adhesive sheet to the adherend becomes so high that it causes a “bend” or the like deformation of a semiconductor wafer or the like adherend when the wafer is polished thin and becomes the cause of adherend fracture in some cases.

As the mono-axially contractible film which forms the heat contractible film layer 21 of the invention, for example, trade name “SPACECLEAN” (mfd. by TOYOBO), trade name “Lumirror” (mfd. by TORAY INDUSTRIES), trade name “ARTON” (mfd. by JSR), trade name “ZEONOR” (mfd. by NIPPON ZEON), trade name “SUNTEC” (mfd. by ASAHI CHEMICAL INDUSTRY) and the like commercial items can be used. As the bi-axially contractible film which forms the heat contractible film layer 21 of the invention, for example, trade name “SPACECLEAN” (mfd. by TOYOBO), trade name “FANCYWRAP” (mfd. by GUNZE), trade name “TORAYFAN” (mfd. by TORAY INDUSTRIES), trade name “LUMIRROR” (mfd. by TORAY INDUSTRIES), trade name “ARTON” (mfd. by JSR), trade name “ZEONOR” (mfd. by NIPPON ZEON), trade name “SUNTEC” (mfd. by ASAHI CHEMICAL INDUSTRY), trade name “SOPRA” (mfd. by SEKISUI FILM), trade name “KOHJIN POLYSET” (mfd. by KOHJIN), trade name “TERRAMAC” (mfd. by UNITIKA) and the like commercial items can be used. In addition, an optional stretching treatment or crosslinking treatment may be applied to the above-mentioned commercial items as occasion demands, and a corona treatment or print processing treatment may be applied to the surface thereof. By applying a stretching treatment, further high contractibility can be added.

(Elastic Layer)

According to the invention, the elastic layer 22 and the first rigid film layer 23 function as a restriction layer which restricts contraction of the heat contractible film layer 21. This restriction layer produces couple of force as the whole self-rolling pressure sensitive adhesive sheet 2 and becomes the driving force of inducing rolling, by restricting contraction of the heat contractible film layer 21 and producing reaction force.

It is desirable that the elastic layer 22 is easy to deform under a temperature at which the contraction of the heat contractible film layer 21 occurs, namely in the state of rubber. However, in the case of a material having fluidity, sufficient reaction force is not produced and the contraction is formed finally by the heat contractible film layer 21 alone, so that the deformation (spontaneous rolling) cannot be generated. Accordingly, a material in which its fluidity is suppressed by a three-dimensional crosslinking or the like is desirable as the elastic layer 22.

In addition, the elastic layer 22 has an action to convert into a uniform contraction direction even by its thickness, by standing against a component of weaker force among non-uniform contraction force of the heat contractible film layer 21 and thereby preventing the contraction deformation by said component of weaker force. It is considered that the bending formed after wafer polishing is formed because the stress in attaching the pressure sensitive adhesive sheet to the wafer remains and the heat contractible film undergo elastic deformation by this residual stress, and the elastic layer 22 also has an action to lower the bending by relaxing this residual stress.

Accordingly, it is desirable that the elastic layer 22 has adhesiveness and is formed using a resin having a glass transition temperature of for example 50° C. or less, preferably room temperature (25° C.) or less, more preferably 0° C. or less. Adhesive strength of the heat contractible film layer 21 side surface of the elastic layer 22 is preferably within the range of 0.5 N/10 mm or more as a value of the 180° peeling test (in accordance with JIS Z 0237, tensile rate 300 mm/min, 50° C.). When this adhesive strength is too low, separation becomes apt to generate between the heat contractible film layer 21 and the elastic layer 22.

In addition, shear modulus G of the elastic layer 22 is from 1×10⁴ Pa to 5×10⁶ Pa at from room temperature (25° C.) to a temperature at the time of separation (e.g., 80° C.), particularly preferably from 0.05×10⁶ Pa to 3×10⁶ Pa. This is because when shear modulus is too small, the action to convert contraction stress of the heat contractible film layer 21 into a stress necessary for rolling becomes poor, and when it is too large on the contrary, in addition to becoming poor in rolling property due to strengthening of rigidity, it becomes difficult to prepare a layered product because those which have high elasticity are generally poor in tackiness and the action to effect relaxation of the residual stress also becomes poor. Thickness of the elastic layer 22 is approximately from 15 to 150 μm. When the aforementioned thickness is too thin, restriction property against contraction of the heat contractible film layer 21 is difficult to obtain and the effect of stress relaxation also becomes small. When it is too thick on the contrary, it is not desirable because the self-rolling property (spontaneous rolling property) is apt to lower and its handling ability and economic value also becomes poor. Accordingly, the product of shear modulus G (e.g., a value at 80° C.) and thickness (i.e., shear modulus G×thickness) is preferably from 1 to 750 N/m (more preferably from 1 to 150 N/m, further preferably from 1.2 to 100 N/m).

As the elastic layer 22, for example, urethane foam, acrylic foam and the like foam materials (foam films) in which an adhesive treatment was applied to the surface (at least the heat contractible film layer 21 side surface), resin films (including sheets) such as non-foam resin films and the like which use rubber, thermoplastic elastomer and the like as the material, and the like can be used.

As the pressure sensitive adhesive to be used in the aforementioned adhesive treatment, there is no particular limitation, and for example, an acrylic type pressure sensitive adhesive, a rubber type pressure sensitive adhesive, a vinyl alkyl ether type pressure sensitive adhesive, a silicone type pressure sensitive adhesive, a polyester type pressure sensitive adhesive, a polyamide type pressure sensitive adhesive, a urethane type pressure sensitive adhesive, an ethylene-diene block copolymer type pressure sensitive adhesive and the like conventionally known pressure sensitive adhesives can be used alone or in combination of two or more species thereof. Particularly, an acrylic type pressure sensitive adhesive is preferably used from the view point of adjusting adhesiveness and the like. In this connection, it is desirable that the resin of the pressure sensitive adhesive to be used in the sticking treatment and the resin of the foam film or non-foam resin film are resins of the same kind in order to obtain high affinity. For example, when an acrylic type pressure sensitive adhesive is used in the sticking treatment, acrylic foam or the like is suitable as the resin film.

In addition, the elastic layer 22 may be formed, for example, using a crosslinking acrylic type pressure sensitive adhesive, a crosslinking polyester type pressure sensitive adhesive or the like resin composition which has adhesiveness by itself. Such a layer (pressure sensitive adhesive layer) formed using a crosslinking acrylic type pressure sensitive adhesive, a crosslinking polyester type pressure sensitive adhesive or the like is suitably used because it is not necessary to apply an adhesive treatment separately, it can be produced by a relatively convenient method and it is excellent in productivity and economy.

The above-mentioned crosslinking acrylic type pressure sensitive adhesive has a structure in which a crosslinking agent is added to an acrylic type pressure sensitive adhesive which uses an acrylic type polymer as the base polymer. As the acrylic type polymer, for example, methyl(meth)acrylate, ethyl(meth)acrylate, butyl (meth)acrylate, 2-ethylhexyl(meth)acrylate, octyl(meth)acrylate and the like (meth)acrylic acid C₁-C₂₀ alkyl esters and the like (meth)acrylic acid alkyl esters, alone or copolymers thereof; copolymers of the aforementioned (meth)acrylic acid alkyl esters with other copolymerizable monomers [e.g., acrylic acid, methacrylic acid, itaconic acid, fumaric acid, maleic anhydride and the like carboxyl group- or acid anhydride-containing monomers; 2-hydroxyethyl(meth)acrylate and the like hydroxyl group-containing monomers; morpholinyl(meth)acrylate and the like amino group-containing monomers; (meth)acrylamide and the like amido group-containing monomers; (meth)acrylonitrile and the like cyano group-containing monomers; isobornyl (meth)acrylate and the like (meth)acrylic esters having an alicyclic hydrocarbon radical], and the like can be cited.

As the acrylic type polymer, particularly, copolymers of one or two or more species of ethyl acrylate, butyl acrylate, 2-ethylhexyl acrylate and the like (meth)acrylic acid C₁-C₂₀ alkyl esters with at least one species of copolymerizable monomer selected from 2-hydroxyethyl acrylate and the like hydroxyl group-containing monomers and acrylic acid and the like carboxyl group- or acid anhydride-containing monomers, or copolymers of one or two or more species of (meth)acrylic acid C₁-C₂₀ alkyl esters with a (meth)acrylic acid ester having an alicyclic hydrocarbon radical and at least one species of copolymerizable monomer selected from a hydroxyl group-containing monomer and a carboxyl group- or acid anhydride-containing monomer, are desirable.

The acrylic type polymer is prepared as a high viscosity liquid prepolymer, for example, by carrying out photo (ultraviolet ray or the like)-polymerization of the monomer component exemplified in the above (and a polymerization initiator) without solvent. Next, a crosslinking acrylic type pressure sensitive adhesive composition can be obtained by adding a crosslinking agent to this prepolymer. In this connection, the crosslinking agent may be added in advance at the time of the prepolymer production. In addition, a crosslinking acrylic type pressure sensitive adhesive composition can also be obtained by adding a crosslinking agent and a solvent (not always necessary when solution of an acrylic polymer is used) to the acrylic type polymer obtained by polymerizing the monomer component exemplified in the above or a solution thereof.

As the crosslinking agent, it is not particularly limited, and for example, an isocyanate type crosslinking agent, a melamine type crosslinking agent, an epoxy type crosslinking agent, an acrylate type crosslinking agent (multifunctional acrylate), a (meth)acrylic acid ester having isocyanate group, and the like can be used. As the acrylate type crosslinking agent, for example, hexanediol diacrylate, 1,4-butanediol diacrylate, trimethylolpropane triacrylate, pentaerythritol tetraacrylate, dipentaerythritol hexaacrylate and the like can be exemplified. As the (meth)acrylic acid ester having isocyanate group, for example, 2-isocyanate ethyl acrylate, 2-isocyanate ethyl methacrylate and the like can be exemplified. Particularly, an acrylate type crosslinking agent (multifunctional acrylate), a (meth)acrylic acid ester having isocyanate group and the like ultraviolet ray (UV)-reactive crosslinking agents are desirable as the crosslinking agent.

Amount of the crosslinking agent to be added is generally from about 0.01 to 150 parts by weight, preferably from about 0.05 to 50 parts by weight, particularly preferably from about 0.05 to 30 parts by weight, based on 100 parts by weight of the above-mentioned base polymer.

In addition to the base polymer and crosslinking agent, the crosslinking acrylic type pressure sensitive adhesive may contain a crosslinking accelerator, a tackifier (e.g., a rosin derivative resin, a polyterpene resin, a petroleum resin, an oil soluble resin or the like), a thickener, a plasticizer, a filler, an age resistor, an antioxidant and the like optional additive agents.

Regarding the crosslinking acrylic type pressure sensitive adhesive layer as the elastic layer 22, an elastic layer 22 which corresponds to the purpose can be obtained conveniently by, for example, making the crosslinking acrylic type pressure sensitive adhesive composition prepared by adding a crosslinking agent to the above-mentioned prepolymer into the shape of a film having desired thickness and area by a casting and the like conventionally known method, and again carrying out light irradiation to accelerate crosslinking reaction (and polymerization of unreacted monomer). Since the elastic layer (crosslinking acrylic type pressure sensitive adhesive layer) obtained in this manner has a self-sticking nature, it can be used by pasting as such between the heat contractible film layer 21 and the first rigid film layer 23. As the crosslinking acrylic type pressure sensitive adhesive layer, a commercially available both-sided adhesive tape such as trade name “HJ-915 OW” manufactured by Nitto Denko Corporation and the like may be used. In this connection, the crosslinking reaction may also be carried out by again carrying out the light irradiation after pasting of the film-shaped pressure sensitive adhesive between the heat contractible film layer 21 and the first rigid film layer 23.

In addition, the crosslinking acrylic type pressure sensitive adhesive layer as the elastic layer 22 can also be obtained by coating a crosslinking acrylic type pressure sensitive adhesive composition, prepared by dissolving the above-mentioned acrylic type polymer and crosslinking agent in a solvent, on the surface of the first rigid film layer 23, pasting the heat contractible film layer 21 thereon and then carrying out the light irradiation.

The above-mentioned crosslinking ester type pressure sensitive adhesive has a construction in which a crosslinking agent is added to an ester type pressure sensitive adhesive which uses an ester type polymer as the base polymer. As the ester type polymer, for example, a polyester composed of a condensation polymerization product of a diol component and a dicarboxylic acid component, and the like can be cited.

As an example of the diol component, for example, a (poly)carbonate diol can be cited. As the (poly)carbonate diol, for example, (poly)hexamethylene carbonate diol, (poly)₃-methyl(pentamethylene) carbonate diol, (poly)trimethylene carbonate diol, copolymers thereof and the like can be cited. In this connection, in case that the (poly)carbonate diol is polycarbonate diol, its polymerization degree is not particularly limited.

As commercial items of the (poly)carbonate diol, for example, trade name “PLACCEL CD208PL”, trade name “PLACCEL CD210PL”, trade name “PLACCEL CD220PL”, trade name “PLACCEL CD208”, trade name “PLACCEL CD210”, trade name “PLACCEL CD220”, trade name “PLACCEL CD208HL”, trade name “PLACCEL CD210HL”, trade name “PLACCEL CD220HL” (mfd. by Daicel Chemical Industries, Ltd.) and the like can be cited.

As the diol component, in addition to the (poly)carbonate diol, ethylene glycol, propylene glycol, butanediol, hexanediol, octanediol, decanediol, octadecanediol and the like components may be jointly used as occasion demands. The diol component or (poly)carbonate diol can be used alone or in combination of two or more species.

As the dicarboxylic acid component, a dicarboxylic acid component which contains, as an essential component, a dicarboxylic acid that has an aliphatic or alicyclic hydrocarbon radical having from 2 to 20 carbon atoms as its molecular skeleton, or a reactive derivative thereof, can be used. Regarding the aforementioned dicarboxylic acid that has an aliphatic or alicyclic hydrocarbon radical having from 2 to 20 carbon atoms as its molecular skeleton, or a reactive derivative thereof, the hydrocarbon radical may be in the form of straight chain or branched chain. As typical examples of such a dicarboxylic acid or reactive derivative thereof, succinic acid, methylsuccinic acid, adipic acid, pimelic acid, azelaic acid, sebacic acid, 1,12-dodecanoic diacid, 1,14-tetradecanoic diacid, tetrahydrophthalic acid, endomethylenetetrahydrophthalic acid and acid anhydrides, lower alkyl esters and the like thereof can be cited. These dicarboxylic acid components can be used alone or as a combination of two or more species.

As the combination of a diol component with a dicarboxylic acid component, polycarbonate diol with sebacic anhydride, adipic acid, pimelic acid, suberic acid, azelaic acid, phthalic acid, maleic acid or the like can be used preferably.

As the crosslinking agent in the case of the crosslinking ester type pressure sensitive adhesive, the crosslinking agent similar to the case of the aforementioned crosslinking acrylic type pressure sensitive adhesive can be used. Amount of the crosslinking agent to be added, additive agent which can be added and method for forming elastic layer are also the same as the case of the aforementioned crosslinking acrylic type pressure sensitive adhesive.

Glass beads, resin beads and the like beads may be further added to the constituting component of the elastic layer 22 of the invention. When glass beads or resin beads are added to the elastic layer 22, it is advantageous from the viewpoint that the adhesive characteristics and shear modulus can be easily controlled. Average particle diameter thereof is for example from 1 to 100 μm, preferably from about 1 to 20 μm. Amount of the beads to be added is for example from 0.1 to 10 parts by weight, preferably from 1 to 4 parts by weight, based on 100 parts by weight of the entire elastic layer 22. When the aforementioned adding amount is too large, the adhesive characteristics are lowered in some cases, and when it is too small, the above-mentioned effect is apt to become insufficient.

(First Rigid Film Layer)

The first rigid film layer 23 has a function to produce force of reaction for shrinkage force of the contractible film layer 21 by providing the restriction layer (elastic layer 22 and first rigid film layer 23) with rigidity or toughness and, further more, to generate couple of force necessary for rolling. By the arrangement of the first rigid film layer 23, when a thermal stimulation is applied to the heat contractible film layer 21, the self-rolling pressure sensitive adhesive sheet 2 can form a cylindrical rolled body with neat shape by smoothly performing spontaneous rolling (self-rolling) without stopping it halfway or shifting the direction.

As the rigid film which constitutes the first rigid film layer 23, for example, there can be mentioned a film composed of one species or two or more species of resins selected from polyethylene terephthalate, polybutylene terephthalate, polyethylene naphthalate and the like polyesters; polyethylene, polypropylene and the like polyolefins; polyimide; polyamide; polyurethane; polystyrene and the like styrene type resins; polyvinylidene chloride; polyvinyl chloride and the like. Particularly, a polyester type resin film, a polypropylene film, a polyamide film and the like are desirable from the viewpoint that these are excellent in the coating workability of pressure sensitive adhesives, and the like. The first rigid film layer 23 may be either a single layer or a multiple layer in which two or more layers are laminated. The rigid film which constitutes the first rigid film layer 23 is non-contractible, and its degree of contraction is for example 5% or less, preferably 3% or less, further preferably 1% or less.

The product of Young's modulus and thickness (Young's modulus×thickness) of the first rigid film layer 23 is preferably 3.0×10⁵ N/m or less (e.g., from 1.0×10² to 3.0×10⁵ N/m), more preferably 2.8×10⁵ N/m or less (e.g., from 1.0×10³ to 2.8×10⁵ N/m), at a temperature at the time of removal (e.g., 80° C.). When the product of Young's modulus and thickness of the first rigid film layer 23 is too small, the action to convert contraction stress of the heat contractible film layer 21 into rolling stress becomes poor and the directional convergence action also becomes apt to lower, and when it is too large on the contrary, the rolling becomes apt to be suppressed by rigidity.

Young's modulus of the first rigid film layer 23 is preferably from 3×10⁶ to 2×10¹° N/m², further preferably from 1×10⁸ to 1×10¹⁰ N/m², at a temperature at the time of removal (e.g., 80° C.). When Young's modulus is too small, it becomes difficult to obtain a cylindrical rolled body rolled into a neat shape, and when it is too large on the contrary, the self-rolling becomes hard to occur. Thickness of the first rigid film layer 23 is for example from 20 to 150 μm, preferably from 25 to 95 μm, further preferably from 30 to 90 μm, particularly preferably from 30 to 80 μm. When the aforementioned thickness is too thin, it becomes difficult to obtain a cylindrical rolled body rolled into a neat shape, and when it is too thick, the self-rolling property is lowered and the handling ability and economy become poor, which are not desirable.

In addition, when the first pressure sensitive adhesive layer 24 is an energy ray curing type pressure sensitive adhesive layer, it is desirable that the first rigid film layer 23 is formed using a material which can easily permeate an energy ray, its thickness can be optionally selected from the viewpoint of its production and workability and it has such an excellent forming ability that it can be easily made into a film shape.

(First Pressure Sensitive Adhesive Layer)

As the first pressure sensitive adhesive layer 24, a pressure sensitive adhesive layer having originally small adhesive strength can also be used, but it is desirably a removable pressure sensitive adhesive layer which has such an adhesiveness that it can be stuck to an adherend and can, after completion of a predetermined role, lower or eliminate the adhesiveness by a certain method (adhesiveness reducing treatment). Such a removable pressure sensitive adhesive layer can be constituted in the same manner as the case of the conventionally known pressure sensitive adhesive layer of removable pressure sensitive adhesive layers. From the viewpoint of self-rolling property, it is desirable that adhesive strength of the pressure sensitive adhesive layer or the pressure sensitive adhesive layer after the adhesiveness reducing treatment (180° peel separation, with respect to silicon mirror wafer, tensile rate of 300 mm/min) is 6.5 N/10 mm or less (particularly 6.0 N/mm or less), for example at ordinary temperature (25° C.).

It is particularly desirable that the first pressure sensitive adhesive layer 24 is an energy ray curing type pressure sensitive adhesive layer. The energy ray curing type pressure sensitive adhesive layer can be constituted by a material which has adhesiveness or pressure-sensitive adhesiveness in early stage and becomes highly elastic by forming a three-dimensional network structure through irradiation of infrared ray, visible light, ultraviolet ray, X ray, electron beam and the like energy rays, and an energy ray curing type pressure sensitive adhesive and the like can be used as such a material. The energy ray curing type pressure sensitive adhesive contains a compound chemically modified with an energy ray reactive functional group for providing energy ray-curing property or an energy ray-curing compound (or an energy ray-curing resin). Accordingly, suitably used as the energy ray curing type pressure sensitive adhesive is the one which is constituted by a base material chemically modified with an energy ray reactive functional group or a composition in which an energy ray-curing compound (or an energy ray-curing resin) is formulated in the base material.

As the aforementioned base material, for example, a conventionally known pressure sensitive adhesive and the like adhesive materials can be used. As the pressure sensitive adhesive, for example, natural rubber and a rubber type pressure sensitive adhesive which uses polyisobutylene rubber, styrene-butadiene rubber, styrene-isoprene-styrene copolymer rubber, regenerated rubber, butyl rubber, polyisobutylene rubber, NBR or the like rubber type polymer as the base polymer; a silicone type pressure sensitive adhesive; an acrylic type pressure sensitive adhesive and the like can be exemplified. Particularly, an acrylic type pressure sensitive adhesive is desirable. The base material may be constituted by one or two or more components.

As the acrylic type pressure sensitive adhesive, for example, acrylic type pressure sensitive adhesives which use, as the base polymers, acrylic type polymers such as methyl(meth)acrylate, ethyl(meth)acrylate, butyl(meth)acrylate, 2-ethylhexyl (meth)acrylate, octyl(meth)acrylate and the like (meth)acrylic acid C₁-C₂₀ alkyl esters and the like (meth)acrylic acid alkyl esters, alone or copolymers thereof; copolymers of said (meth)acrylic acid alkyl esters with other copolymerizable monomers [e.g., acrylic acid, methacrylic acid, itaconic acid, fumaric acid, maleic anhydride and the like carboxyl group- or acid anhydride-containing monomers; 2-hydroxyethyl (meth)acrylate and the like hydroxyl group-containing monomers; morpholinyl (meth)acrylate and the like amino group-containing monomers; (meth)acrylamide and the like amido group-containing monomers and the like], and the like can be exemplified. These can be used alone or in combination of two or more species.

As the energy ray reactive functional group to be used in the chemical modification for energy ray-curing an energy ray curing type adhesive and the energy ray-curing compound, they are not particularly limited with the proviso that they can perform curing by infrared ray, ultraviolet ray, X ray, electron beam and the like energy rays, but those which can efficiently result in the formation of a three-dimensional net-like shape (network shape) of the energy ray curing type adhesive after irradiation of an energy ray are desirable. These can be used alone or in combination of two or more species. As the energy ray reactive functional group to be used in the chemical modification, for example, acryloyl group, methacryloyl group, vinyl group, allyl group, acetylene group and the like functional groups having carbon-carbon multiple bond, and the like can be cited. According to these functional groups, a radical is formed through cleavage of the carbon-carbon multiple bond due to irradiation of an energy ray so that a three-dimensional network structure can be formed through this radical as the crosslinking point. Particularly, (meth)acryloyl group is desirable from the viewpoint of reactivity and workability; for example, it can show relatively high reactivity for the energy ray, and also those which are selected from plentiful species of acrylic type pressure sensitive adhesives can be used in combination.

As a typical example of the base material chemically modified with an energy ray reactive functional group, there can be mentioned a polymer obtained by allowing a compound having, in its molecule, a group which reacts with the reactive functional group described in the following (isocyanate group, epoxy group or the like) and an energy ray reactive functional group (acryloyl group, methacryloyl group or the like) [e.g., (meth)acryloyloxy-ethylene isocyanate or the like] to react with a reactive functional group-containing acrylic type polymer prepared by copolymerizing a monomer that contains hydroxyl group, carboxyl group or the like reactive functional group [e.g., 2-hydroxyethyl(meth)acrylate, (meth)acrylic acid or the like] with a (meth)acrylic acid alkyl ester.

Ratio of the reactive functional group-containing monomer in the aforementioned reactive functional group-containing acrylic type polymer is for example from 5 to 40% by weight, preferably from 10 to 30% by weight, based on the total monomers. Amount of the compound having a group which reacts with the aforementioned reactive functional group and an energy ray reactive functional group in its molecule, to be used in allowing it to react with the aforementioned reactive functional group-containing acrylic type polymer, is for example from 50 to 100% by mol, preferably from 60 to 95% by mol, based on the reactive functional group (hydroxyl group, carboxyl group or the like) in the reactive functional group-containing acrylic type polymer.

As the energy ray curing compound, for example, trimethylolpropane triacrylate, tetramethylolmethane tetraacrylate, pentaerythritol triacrylate, pentaerythritol tetraacrylate, dipentaerythritol monohydroxy pentaerythritol, dipentaerythritol hexaacrylate, 1,4-butanediol diacrylate, 1,6-hexanediol diacrylate, polyethylene glycol diacrylate and the like poly(meth)acryloyl group-containing compounds or the like compounds having two or more carbon-carbon double bonds, and the like can be cited. These compounds may be used alone or in combination of two or more species. In particular, a poly(meth)acryloyl group-containing compound is suitable, which is exemplified for example in JP-A-2003-292916, herein incorporated by reference. In the following, the poly(meth)acryloyl group-containing compound is referred sometimes to as “acrylate type crosslinking agent”.

Also can be used as the energy ray curing compound is a mixture of an onium salt and the like organic salts with a compound having two or more heterocyclic rings in its molecule, and the like. In the aforementioned mixture, an organic salt undergoes cleavage by irradiation of an energy ray to form an ion which becomes the initiator to induce ring-opening reaction of the heterocyclic rings, thereby enabling formation of the three-dimensional network structure. The aforementioned organic salts include an iodonium salt, a phosphonium salt, an antimonium salt, a sulfonium salt, a borate salt and the like, and the heterocyclic ring in the aforementioned compound having two or more heterocyclic rings in its molecule includes oxirane, oxetane, oxolane, thiirane, aziridine and the like. Illustratively, the compounds described in Hikari Koka Gijutsu (Photo-curing Techniques) (2000), edited by Gijutsu Joho Kyokai (Technical Information Association), which is herein incorporated by reference, and the like can be used.

As the energy ray curing resin, for example, (meth)acrylate of an ester having (meth) acryloyl group on its molecular terminus, urethane (meth)acrylate, epoxy(meth) acrylate, melamine (meth)acrylate, an acrylic resin (meth)acrylate, a thiol-ene addition type resin or light cation polymerization type resin having allyl group on its molecular terminus, a polymer containing polyvinyl cinnamate or the like cinnamoyl group-containing polymer, a diazotated amino-novolak resin, an acrylamide type polymer and the like photosensitive reaction group-containing polymers or oligomers and the like can be cited. As a polymer which reacts by a further high energy ray, an epoxydated polybutadiene, an unsaturated polyester, polyglycidyl methacrylate, polyacrylamide, polyvinylsiloxane and the like can be cited. In this connection, when a energy ray curing resin is used, the aforementioned base material is not always necessary.

As the energy ray curing type pressure sensitive adhesive, those which are composed of a combination of the aforementioned acrylic type polymer or an acrylic polymer chemically modified with an energy ray reactive functional group (acrylic type polymer in which an energy ray reactive functional group is introduced into its side chain) and the aforementioned energy ray curing compound (a compound having two or more carbon-carbon double bonds) are particularly desirable. The aforementioned combination is desirable from the viewpoint of reactivity and workability, because it contains acrylate group which shows relatively high reactivity for an energy ray and can be selected from a great variety of acrylic type pressure sensitive adhesives. As illustrative examples of such a combination, a combination of an acrylic type polymer in which acrylate group is introduced into its side chain and a compound having two or more functional groups (particularly acrylate group) having carbon-carbon double bond, and the like can be cited. As such a combination, those which are disclosed in JP-A-2003-292916 and the like can be used.

As the method for preparing the aforementioned acrylic type polymer in which acrylate group is introduced in its side chain, for example, a method in which acryloyloxyethyl isocyanate, methacryloyloxyethyl isocyanate or the like isocyanate compound is bonded, via urethane bond, to an acrylic type polymer containing hydroxyl group in its side chain, and the like can be used.

Blending amount of the energy ray curing compound is, for example, within the range of approximately from 0.5 to 200 parts by weight, preferably from 5 to 180 parts by weight, further preferably from 20 to 130 parts by weight, based on 100 parts by weight of the base material (e.g., the aforementioned acrylic type polymer or an acrylic type polymer chemically modified with an energy ray reactive functional group).

With the aim of improving reaction rate of the three-dimensional network structure formation, an energy ray polymerization initiator for curing the compound which provides energy ray curing property may be formulated in the energy ray curing type pressure sensitive adhesive.

Regarding the energy ray polymerization initiator, a conventionally known initiator can be optionally selected in response to the kind of energy ray to be used (e.g., infrared ray, visible light, ultraviolet ray, X ray, electron beam or the like). A compound which can perform photo-polymerization initiation by ultraviolet ray is desirable from the viewpoint of working efficiency. As typical energy ray polymerization initiator, benzophenone, acetophenone, quinone, naphthoquinone, anthraquinone, fluorenone and the like ketone type initiators; azobisisobutyronitrile and the like azo type initiators; benzoyl peroxide, perbenzoic acid and the like peroxide type initiators, and the like can be cited, though not limited thereto. As commercial items, for example, there are trade names “IRGACURE 184”, “IRGACURE 651” and the like, manufactured by Ciba-Geigy Corp.

The energy ray polymerization initiator can be used alone or by mixing two or more species. Regarding blending amount of the energy ray polymerization initiator, it is generally from about 0.01 to 10 parts by weight, preferably from about 1 to 8 parts by weight, based on 100 parts by weight of the above-mentioned base material. In this connection, an energy ray polymerization accelerator may be jointly used together with the aforementioned energy ray polymerization initiator, as occasion demands.

In addition to the above-mentioned components, the energy ray curing type pressure sensitive adhesive is blended as occasion demands with a crosslinking agent, a curing (crosslinking) accelerator, a tackifier, a curing agent, a thickener and the like in order to obtain appropriate stickiness before and after the energy ray curing, and with an age resistor, antioxidant and the like optional additive agents in order to improve durability.

As a desirable energy ray curing type pressure sensitive adhesive, for example, a composition in which an energy ray curing compound is formulated in a base material (pressure sensitive adhesive), preferably a UV curing type pressure sensitive adhesive in which a UV curing compound is formulated in an acrylic type pressure sensitive adhesive, is used. As particularly preferable embodiment of the energy ray curing type pressure sensitive adhesive, an ultraviolet ray curing type pressure sensitive adhesive which contains a side chain acrylate-containing acrylic pressure sensitive adhesive, an acrylate type crosslinking agent (a poly(meth)acryloyl group-containing compound; multifunctional acrylate) and an ultraviolet ray photo-initiator are used. The side chain acrylate-containing acrylic pressure sensitive adhesive means an acrylic type polymer in which acrylate group is introduced into its side chain, and the same substances described in the above can be prepared by the same method. The acrylate type crosslinking agent is a low molecular compound exemplified in the above as a poly(meth)acryloyl group-containing compound. As the ultraviolet ray photo-initiator, those which are exemplified in the above as typical energy ray polymerization initiators can be used.

In this connection, when the first pressure sensitive adhesive layer 24 is constituted by an energy ray curing type pressure sensitive adhesive, its adhesive strength after energy ray irradiation (180° peel separation, with respect to silicon mirror wafer, tensile rate of 300 mm/min) generally becomes 0.01 N/10 mm or less at ordinary temperature (25° C.).

In addition, as the pressure sensitive adhesive which constitutes the first pressure sensitive adhesive layer 24, it is also possible to use a non-energy ray curing type pressure sensitive adhesive that uses the above-mentioned acrylic type pressure sensitive adhesive as the base material. In that case, those which have an adhesive strength of smaller than the peeling stress in forming a cylindrical rolled body can be employed, and for example, those which have an adhesive strength of 6.5 N/10 mm or less (e.g., from 0.05 to 6.5 N/10 mm, preferably from 0.2 to 6.5 N/10 mm), particularly 6.0 N/10 mm or less (e.g., from 0.05 to 6.0 N/10 mm, preferably from 0.2 to 6.0 N/10 mm), in accordance with the 180° peel separation test (room temperature (25° C.)) employing a silicon mirror wafer as the adherend, can be used.

As the non-energy ray curing type pressure sensitive adhesive which uses such an acrylic type pressure sensitive adhesive having small adhesive strength as the base material, an acrylic type pressure sensitive adhesive crosslinked by adding a crosslinking agent capable of reacting with the aforementioned reactive functional groups [e.g., an isocyanate type crosslinking agent, a melamine type crosslinking agent, an epoxy type crosslinking agent or the like] to a copolymer of a (meth)acrylic acid alkyl ester [e.g., methyl(meth)acrylate, ethyl(meth)acrylate, butyl(meth)acrylate, 2-ethylhexyl(meth)acrylate, octyl(meth)acrylate or the like (meth)acrylic acid C₁-C₂₀ alkyl esters], a monomer having a reactive functional group [e.g., acrylic acid, methacrylic acid, itaconic acid, fumaric acid, maleic anhydride or the like carboxyl group- or acid anhydride-containing monomer; 2-hydroxyethyl(meth)acrylate or the like hydroxyl group-containing monomer; morpholinyl(meth)acrylate or the like amino group-containing monomer; (meth)acrylamide or the like amido group-containing monomer or the like], and other copolymerizable monomer which is used as occasion demands [e.g., isobornyl(meth)acrylate or the like (meth)acrylic acid ester having an alicyclic hydrocarbon radical, acrylonitrile or the like], and the like can be preferably used.

The first pressure sensitive adhesive layer 24 can be formed by a conventionally used method such as, for example, a method in which a coating liquid prepared by adding a pressure sensitive adhesive, an energy ray curable compound, and an optional solvent, is applied to the surface of the first rigid film layer 23; a method in which a pressure sensitive adhesive layer is formed by applying the aforementioned coating liquid onto an appropriate release liner (separator), and this is transcribed (transferred) onto the first rigid film layer 23; and the like. In the case of the transferring, there is a case where voids (air gaps) remain on the boundary face between the pressure sensitive adhesive layer and the first rigid film layer 23. In that case, the voids can be dispersed and extinguished by applying a humidification pressurization treatment through an autoclave treatment or the like. The first pressure sensitive adhesive layer 24 may be either a single layer or a multiple layer.

Glass beads, resin beads or the like beads may be added to constituting components of the first pressure sensitive adhesive layer 24 of the invention. When grass beads or resin beads are added to the first pressure sensitive adhesive layer 24, it becomes easy to lower the adhesive strength by increasing shear modulus. Average particle diameter of the beads is for example from about 1 to 100 μm, preferably from about 1 to 20 μm. Amount of the beads to be added is for example from 25 to 200 parts by weight, preferably from 50 to 100 parts by weight, based on 100 parts by weight of whole of the first pressure sensitive adhesive layer 24. When the aforementioned adding amount is too large, it becomes difficult in some cases to apply the pressure sensitive adhesive due to generation of poor dispersion, and when it is too small, the above-mentioned effect is apt to become insufficient.

Thickness of the first pressure sensitive adhesive layer 24 is generally from 10 to 200 μm, preferably from 20 to 100 μm, further preferably from 30 to 60 μm. When the aforementioned thickness is too thin, it easily becomes difficult to keep and tentatively fix the adherend due to insufficient adhesive strength, and too thick thickness is not desirable because it is uneconomical and also results in inferior handling ability.

The self-rolling pressure sensitive adhesive sheet 2 can be produced by superposing the heat contractible film layer 21, elastic layer 22 and first rigid film layer 23, effecting their lamination by optionally and selectively using a hand roller, laminator or the like lamination means and an autoclave or the like atmospheric pressure compression means in accordance with the object, and then arranging the first pressure sensitive adhesive layer 24 on the surface of the first rigid film layer 23 of this laminate, or by superposing the first rigid film layer 23 arranged in advance with the first pressure sensitive adhesive layer 24 on the one side thereof together with the heat contractible film layer 21 and elastic layer 22, and laminating them.

As described in the foregoing, the self-rolling pressure sensitive adhesive sheet of the invention can form a cylindrical rolled body through float up and spontaneous rolling of the edge part when a thermal stimulus is provided as a cause of contraction.

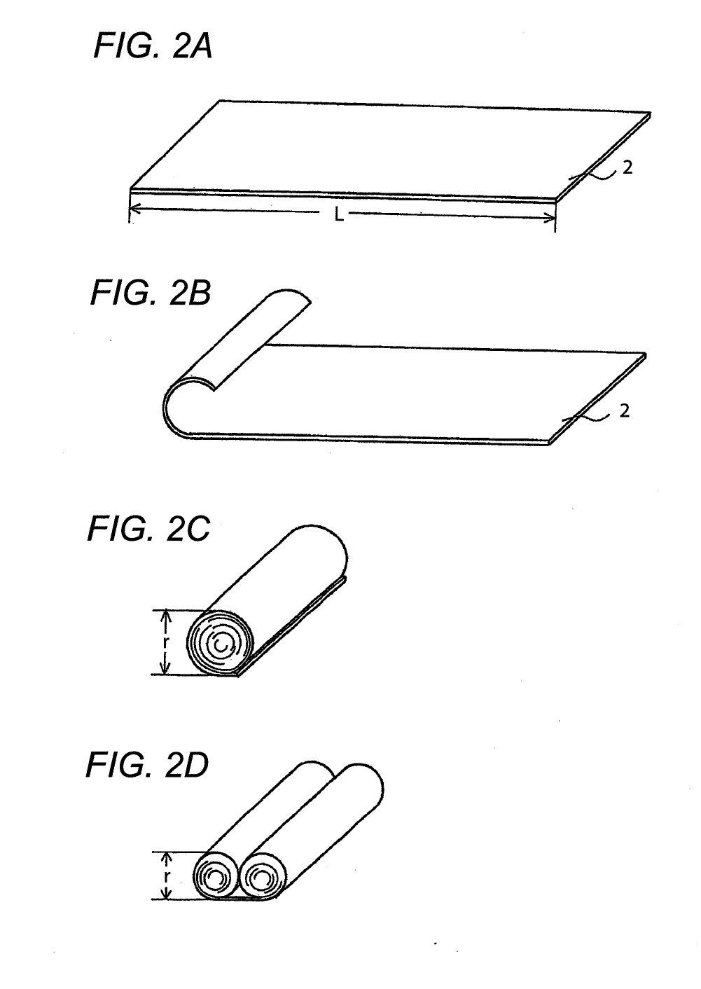

FIGS. 2A to 2D are views (perspective illustration) showing an example of self-rolling condition of the self-rolling pressure sensitive adhesive sheet 2 of the invention. FIG. 2A is a view showing the self-rolling pressure sensitive adhesive sheet 2 before a thermal stimulus which becomes a cause of contraction of the heat contractible film layer. FIG. 2B is a view showing a condition in which the self-rolling pressure sensitive adhesive sheet 2, wherein the contraction-causing thermal stimulus is added to the heat contractible film layer to start rolling from a peripheral region of the sheet (one edge part) toward one direction (generally, main contraction axis direction of the heat contractible film layer). FIG. 2C is a view showing a condition when rolling of the sheet is completed and one cylindrical rolled body is formed (one direction rolling). In addition, FIG. 2D is a view showing a condition when two cylindrical rolled bodies are formed by spontaneously rolling from facing two edge parts of the sheet toward the center (generally, main contraction axis direction of the heat contractible film layer) (two direction rolling). Whether the self-rolling pressure sensitive adhesive sheet 2 causes one direction rolling or causes two direction rolling varies depending on the adhesive strength of the restriction layer (elastic layer 22 and first rigid film layer 23) with respect to the heat contractible film layer 21, shear modulus of the restriction layer (particularly elastic layer 22) and the like.

In FIG. 2A, L represents length (diameter when the self-rolling pressure sensitive adhesive sheet has a circular shape) in the rolling direction of the self-rolling pressure sensitive adhesive sheet 2 (generally, main contraction axis direction of the heat contractible film layer). In FIGS. 2C and 2D, r represents diameter of the formed cylindrical rolled body (maximum diameter when diameter of the cylindrical rolled body is not constant in the longitudinal direction of the rolled body like, such as a case in which the self-rolling pressure sensitive adhesive sheet has a circular shape or the like). According to the self-rolling pressure sensitive adhesive sheet of the invention, the value of r/L is within the range of preferably from 0.001 to 1, more preferably from 0.001 to 0.333, particularly preferably from 0.01 to 0.2. In this connection, the value of r/L of this case is a value obtained by soaking one edge part of the self-rolling pressure sensitive adhesive sheet having a size of 100 mm×100 mm in hot water of 80° C., along contraction axis direction of the heat contractible film, thereby accelerating its deformation, measuring diameter of the thus obtained cylindrical rolled body using a ruler, and dividing this value by 100 mm.

The value of r/L can be set within the abode-mentioned range by adjusting kind, composition, thickness and the like of the material of each layer of the heat contractible film layer 21 and restriction layer (elastic layer 22 and first rigid film layer 23), particularly shear modulus and thickness of the elastic layer 22 and Young's modulus and thickness of the first rigid film layer 23. In this example, shape of the self-rolling pressure sensitive adhesive sheet 2 is a square, but is not limited thereto and can be optionally selected in response to the purpose and is may be any one of a circular shape, an oval shape, a polygonal shape and the like.

In this connection, the self-rolling pressure sensitive adhesive sheet 2 rolls in the same manner even when the length L in the rolling direction of the sheet is long. Accordingly, lower limit of the ratio (r/L) of the diameter r of the cylindrical rolled body formed by performing spontaneous rolling when a thermal stimulus is applied to said self-rolling pressure sensitive adhesive sheet and the length L in the rolling direction of said self-rolling pressure sensitive adhesive sheet becomes smaller as the rolling direction length L of the self-rolling pressure sensitive adhesive sheet becomes larger.

According to the self-rolling pressure sensitive adhesive sheet 2 of the invention, a separator (release liner) may be arranged on the surface of the first pressure sensitive adhesive layer 24 from the view points of the protection and blocking prevention of the surface of the first pressure sensitive adhesive layer 24, and the like. The separator is a means which is peeled off when the self-rolling pressure sensitive adhesive sheet 2 is stuck to an adherend. The separator to be used is not particularly limited, and conventionally used release paper and the like can be used. For example, a base material having plastic film, paper or the like release layer surface-treated with a release agent of a silicone type, long chain alkyl type, fluorine type, molybdenum sulfide type or the like; a low adhesive base material composed of a fluorine type polymer such as polytetrafluoroethylene, polychlorotrifluoroethylene, polyvinyl fluoride, polyvinylidene fluoride, tetrafluoroethylene-hexafluoropropylene copolymer, chlorofluoroethylene-vinylidene fluoride copolymer or the like; a low adhesive base material composed of an olefinic resin (e.g., polyethylene, polypropylene or the like) or the like non-polar polymer; and the like can be used.

(Pressure Sensitive Adhesive Sheet Layer)

In the removable pressure sensitive adhesive sheet of the invention, a pressure sensitive adhesive sheet layer 3 is laminated on the heat contractible film layer 21 side of the self-rolling pressure sensitive adhesive sheet 2. The pressure sensitive adhesive sheet layer 3 includes a second pressure sensitive adhesive layer 32 on the self-rolling pressure sensitive adhesive sheet 2 side and a second rigid film layer 31 on the side opposite to the self-rolling pressure sensitive adhesive sheet 2 side.

The pressure sensitive adhesive sheet layer 3 has an action of providing the self-rolling pressure sensitive adhesive sheet 2 with heat resistance and has the action of preventing separation of the self-rolling pressure sensitive adhesive sheet 2 from an adherend when a processing which includes a heating step is applied to the adherend. As described in the foregoing, the self-rolling pressure sensitive adhesive sheet 2 undergoes rolling-separation due to generation of couple of force caused by thermal contraction force of the outermost layer, i.e., heat contractible film layer 21 upon heating, and reaction of the first rigid film layer 23. By laminating the pressure sensitive adhesive sheet layer 3 on this self-rolling pressure sensitive adhesive sheet 2, generation of a couple of force half-turn to the couple of force generating in the self-rolling pressure sensitive adhesive sheet 2 is effected to inhibit rolling separation of the self-rolling pressure sensitive adhesive sheet 2. Also, since total thickness as a removable pressure sensitive adhesive sheet (tape) is increased by lamination of the pressure sensitive adhesive sheet layer 3, it can also be considered that flexural rigidity of the removable pressure sensitive adhesive sheet is also improved so that the rolling becomes apt to be inhibited. In addition, when the pressure sensitive adhesive sheet layer 3 alone (or the second rigid film layer 31 alone) is released after the heating step and then heating is carried out at a temperature at which the heat contractible film layer 21 of the self-rolling pressure sensitive adhesive sheet 2 undergoes contraction, it becomes possible to cause rolling-separation of the self-rolling pressure sensitive adhesive sheet 2.

In this connection, when the removable pressure sensitive adhesive sheet of the invention is stuck to an adherend, the self-rolling pressure sensitive adhesive sheet 2 and pressure sensitive adhesive sheet layer 3, in the state of being laminated together in advance, may be stuck to the adherend, or the removable pressure sensitive adhesive sheet may be formed by firstly sticking the self-rolling pressure sensitive adhesive sheet 2 to the adherend and then laminating the pressure sensitive adhesive sheet layer 3 on the heat contractible film layer 21 side of this self-rolling pressure sensitive adhesive sheet 2. After completion of the processing of the adherend, the pressure sensitive adhesive sheet layer 3 (or second rigid film layer 31) is peeled off from the self-rolling pressure sensitive adhesive sheet 2 before separation of the self-rolling pressure sensitive adhesive sheet 2 from the adherend, preferably after cooling the adherend to which the removable pressure sensitive adhesive sheet is stuck.

(Second Rigid Film Layer)

The second rigid film layer 31 functions as a support base material of the pressure sensitive adhesive sheet layer 3. As the second rigid film layer 31, it is desirable to use a heat resistant base material, and for example, various resin films and sheets and the like plastic system base materials; rubber sheets and the like rubber system base materials; metal foils, metal plates and the like metal system base materials and laminates of the same or different species thereof, and the like optional thin leaf bodies can be used. As the material or raw material of the above-mentioned plastic system base materials, for example, a polyester (polyethylene terephthalate, polyethylene naphthalate, polybutylene terephthalate, polybutylene naphthalate or the like), a polyolefin (polyethylene, polypropylene, an ethylene-propylene copolymer or the like), polyvinyl alcohol, polyvinylidene chloride, polyvinyl chloride, a vinyl chloride-vinyl acetate copolymer, polyvinyl acetate, polyamide, polyimide, celluloses, a fluorine system resin, a polyether, a polystyrene system resin (polystyrene or the like), a polycarbonate, a polyether sulfone and the like can be cited. Among these, a plastic film, particularly polyethylene terephthalate film, polyethylene naphthalate film or the like polyester film, polypropylene film or polyimide film, is desirable as the second rigid film layer 31.

In addition, those in which the second pressure sensitive adhesive layer side surface of the heat resistant base material exemplified in the above is release-treated with a silicone type, long chain alkyl type, fluorine type, molybdenum sulfide type or the like releasing agent can also be used as the second rigid film layer 31. In that case, after completion of the processing of the adherend to which the removable pressure sensitive adhesive sheet 1 of the invention has been stuck, the pressure sensitive adhesive sheet layer 3 may not be peeled off but only the second rigid film layer 31 whose surface has been release-treated may be peeled off, followed by rolling-separating the layered product of the self-rolling pressure sensitive adhesive sheet 2 and second pressure sensitive adhesive layer 32. In this connection, as the second pressure sensitive adhesive layer 32 in such a case, it is necessary to select modulus of elasticity, thickness and the like of the second pressure sensitive adhesive layer 32 such that it does not inhibit self-rolling of the self-rolling pressure sensitive adhesive sheet 2.

It is desirable that the second rigid film layer 31 shows an appropriate rigidity, for example, a rigidity equivalent to that of the first rigid film layer 23 of the self-rolling pressure sensitive adhesive sheet 2 at the time of heating. Young's modulus E′ of the second rigid film layer 31 at the rolling separation temperature of the self-rolling pressure sensitive adhesive sheet 2 (e.g., 80° C.) is, for example, from 1×10⁶ Pa to 2×10¹⁰ Pa, preferably from 1×10⁸ Pa to 1×10¹° Pa. When Young's modulus of the second rigid film layer 31 is too small, a level of anti-couple of force sufficient enough for resisting the couple of force generated in the self-rolling pressure sensitive adhesive sheet 2 cannot be generated, so that there is a possibility of causing rolling-separation of the self-rolling pressure sensitive adhesive sheet 2 during the heating step or generation of floating at an edge part of the self-rolling pressure sensitive adhesive sheet 2. When Young's modulus of the second rigid film layer 31 is too large, workability at the time of peeling off the pressure sensitive adhesive sheet layer 3 (e.g., by peel separation) is apt to be lowered.

Thickness of the second rigid film layer 31 is generally about 10 μm or more (e.g., from 10 to 500 μm), preferably about 25 μm or more (e.g., from 25 to 250 μm). When the second rigid film layer 31 is too thin, sticking workability of the pressure sensitive adhesive sheet layer 3 is apt to become low so that the reaction against heat contraction of the heat contractible film layer 21, sufficient enough for generating half turn couple force, cannot be produced, thus posing a possibility that the self-rolling pressure sensitive adhesive sheet 2 is peeled off from the adherend at the time of its heat processing. When the second rigid film layer 31 is too thick, workability at the time of peeling off the pressure sensitive adhesive sheet layer 3 (e.g., by peel separation) is apt to be lowered.

In order to improve its adhesiveness with the second pressure sensitive adhesive layer 32, a conventionally used surface treatment, such as an oxidation treatment by a chromic acid treatment, ozone exposure, flame exposure, high voltage electric shock exposure, ionized radiation treatment or the like chemical or physical method, or the like may be applied to the surface of the second rigid film layer 31, as occasion demands.

(Second Pressure Sensitive Adhesive Layer)

As the pressure sensitive adhesive which constitutes the second pressure sensitive adhesive layer 32, any one of the acrylic type, rubber type, silicone type, polyester type and the like pressure sensitive adhesives can be used, and any one of the energy ray curing type pressure sensitive adhesives and non-energy ray curing type pressure sensitive adhesives can also be used. In addition, it may be any one of the pressure sensitive type, ultraviolet ray curing type, thermosetting type, thermoplastic type (heat sensitive type) and the like pressure sensitive adhesives. As these pressure sensitive adhesives, the pressure sensitive adhesives described in the explanatory parts on the aforementioned elastic layer 22 and first pressure sensitive adhesive layer 24 can be used.

As the pressure sensitive adhesive which constitutes the second pressure sensitive adhesive layer 32, among the above-mentioned ones, the acrylic type pressure sensitive adhesives and silicone type pressure sensitive adhesives are desirable from the viewpoint that control of modulus of elasticity of the second pressure sensitive adhesive layer 32 is easy.

It is desirable that the second pressure sensitive adhesive layer 32 has such a high elasticity that deformation is not generated by contraction stress of the heat contractible film layer 21 of the self-rolling pressure sensitive adhesive sheet 2. By making the second pressure sensitive adhesive layer 32 into a high elasticity pressure sensitive adhesive layer, a half turn couple of force can be efficiently generated and heat resistance cab be provided.

Shear modulus of the second pressure sensitive adhesive layer 32 at the rolling separation temperature of the self-rolling pressure sensitive adhesive sheet 2 (e.g., 80° C.) is, for example, 4×10⁴ Pa or more (e.g., from 4×10⁴ Pa to 1×10⁷ Pa), preferably 1×10⁵ Pa or more (e.g., from 1×10⁵ Pa to 1×10⁷ Pa), further preferably 3×10⁵ Pa or more (e.g., from 3×10⁵ Pa to 1×10⁷ Pa). When shear modulus of the second pressure sensitive adhesive layer 32 is too low, contraction stress of the heat contractible film layer 21 of the self-rolling pressure sensitive adhesive sheet 2 is relaxed by the second pressure sensitive adhesive layer 32 so that it becomes difficult to obtain a half turn couple of force for inhibiting the rolling.

Thickness of the second pressure sensitive adhesive layer 32 is within the range of for example from 1 to 500 μm, preferably from 5 to 100 μm, further preferably from 10 to 50 μm. When the second pressure sensitive adhesive layer 32 is too thin, it becomes difficult to obtain sufficient adhesiveness for the heat contractible film layer 21 of the self-rolling pressure sensitive adhesive sheet 2. Also, when the second pressure sensitive adhesive layer 32 is too thick, it results in the relaxation of contraction stress of the heat contractible film layer 21 of the self-rolling pressure sensitive adhesive sheet 2, so that inhibition of the rolling becomes difficult to attain.

Modulus of elasticity and adhesive strength of the second pressure sensitive adhesive layer 32 can be controlled by adding a crosslinking agent, a plasticizer, fillers (glass beads, resin beads or the like), an initiator and the like suitable additives thereto.

The second pressure sensitive adhesive layer 32 can be formed by a conventionally used method such as, for example, a method in which a coating liquid prepared by adding a pressure sensitive adhesive and as occasion demands, an energy ray curable compound, a solvent and appropriate additives, to the surface of the second rigid film layer 31, a method in which a pressure sensitive adhesive layer is formed by applying the aforementioned coating liquid onto an appropriate release liner (separator), and this is transcribed (transferred) onto the second rigid film layer 31, and the like. In the case of the transferring, there is a case where voids (air gaps) remain on the boundary face between the pressure sensitive adhesive layer and the second rigid film layer 31. In that case, the voids can be dispersed and extinguished by applying a humidification pressurization treatment through an autoclave treatment or the like. The second pressure sensitive adhesive layer 32 may be either a single layer or a multiple layer.

After the processing including heating step of the adherend, when the pressure sensitive adhesive sheet layer 3 (second rigid film layer 31 when a release layer is arranged on the surface of the second rigid film layer 31) is peeled off, the pressure sensitive adhesive sheet layer 3 (or the second rigid film layer 31) can be peeled off from the backside of the self-rolling pressure sensitive adhesive sheet 2 (or the second pressure sensitive adhesive layer 32) after the heating step, by materializing a relation of [adhesive strength of the self-rolling pressure sensitive adhesive sheet 2 with respect to the adherend>adhesive strength of the pressure sensitive adhesive sheet layer 3 with respect to the heat contractible film layer 21 of the self-rolling pressure sensitive adhesive sheet 2 (adhesive strength of the second rigid film layer 31 with respect to the second pressure sensitive adhesive layer 32 in case that a release layer is arranged on the surface of the second rigid film layer 31)]. And thereafter, the self-rolling pressure sensitive adhesive sheet 2 (or the self-rolling pressure sensitive adhesive sheet 2 and second pressure sensitive adhesive layer 32) can be rolled and separated by heating the self-rolling pressure sensitive adhesive sheet 2 (or self-rolling pressure sensitive adhesive sheet 2 and second pressure sensitive adhesive layer 32) remained on the adherend.

Adhesive strength of the second pressure sensitive adhesive layer 32 (adhesive strength after energy ray irradiation in case that the second pressure sensitive adhesive layer 32 is constituted by an energy ray curing type pressure sensitive adhesive) (180° peel separation, with respect to silicon mirror wafer, tensile rate of 300 mm/min) is, for example at ordinary temperature (25° C.), 6.0 N/10 mm or less (e.g., from 0.05 to 6.0 N/10 mm), preferably 3.0 N/10 mm or less (e.g., from 0.05 to 3.0 N/10 mm), further preferably 1.0 N/10 mm or less (e.g., from 0.05 to 1.0 N/10 mm). In this connection, when a release layer is arranged on the surface of the second rigid film layer 31, adhesive strength of the second pressure sensitive adhesive layer 32 may be larger than the above-mentioned range. When the second pressure sensitive adhesive layer 32 is constituted by an energy ray curing type pressure sensitive adhesive, the adhesive strength after energy ray irradiation (180° peel separation, with respect tp silicon mirror wafer, tensile rate of 300 mm/min) generally becomes 0.01 N/10 mm or less, for example at ordinary temperature (25° C.).

In this connection, when size of the pressure sensitive adhesive sheet layer 3 is enlarged than the size of the self-rolling pressure sensitive adhesive sheet 2, the remaining part can be used as a separating chance so that separation of the pressure sensitive adhesive sheet layer 3 can be carried out easier.

From the viewpoint of protection and blocking prevention of the surface of the second pressure sensitive adhesive layer 32 of the pressure sensitive adhesive sheet layer 3, a separator (release liner) may be arranged on surface of the second pressure sensitive adhesive layer 32 before laminating it on the self-rolling pressure sensitive adhesive sheet 2. The separator is not particularly limited, and the same examples of the aforementioned separators can be cited.

As the pressure sensitive adhesive sheet layer 3, it is desirable to use a base material-equipped pressure sensitive adhesive sheet prepared in advance (including a tape) (e.g., a weakly pressure sensitive adhesive sheet or tape equipped with a base material).

The removable pressure sensitive adhesive sheet of the invention can be used, for example, as a pressure sensitive adhesive sheet for protecting a semiconductor and the like or a pressure sensitive adhesive sheet for fixing a semiconductor wafer, and more illustratively can be used, for example, as a pressure sensitive adhesive sheet for silicon semiconductor back grind use, a pressure sensitive adhesive sheet for compound semiconductor back grind use, a pressure sensitive adhesive sheet for silicon semiconductor dicing use, a pressure sensitive adhesive sheet for chemical semiconductor dicing use, a pressure sensitive adhesive sheet for semiconductor package dicing use, a pressure sensitive adhesive sheet for glass dicing use, a pressure sensitive adhesive sheet for ceramics dicing use and the like. Particularly, it is useful as a pressure sensitive adhesive sheet for semiconductor protection use, a pressure sensitive adhesive sheet for semiconductor wafer fixing use and the like pressure sensitive adhesive sheets for semiconductor use. In addition, it is most particularly useful as a pressure sensitive adhesive sheet for tentative fixing use in the case of applying a processing which includes a heating step [e.g., spattering or deep reactive ion etching (DRIE)] to an adherend.

Method for Processing Adherend

An adherend processing method of the invention includes a processing step of applying a certain processing to a adherend to which the aforementioned removable pressure sensitive adhesive sheet of the invention has been attached, and after said processing step, a step of peeling off (1) the second pressure sensitive adhesive layer and second rigid film layer or (2) the second rigid film layer of the aforementioned removable pressure sensitive adhesive sheet and then effecting rolling and separation of (1) the self-rolling pressure sensitive adhesive sheet or (2) the self-rolling pressure sensitive adhesive sheet and the second pressure sensitive adhesive layer, from the adherend by a heating treatment. The processing step of adherend may include a heating step of 80° C. or more.

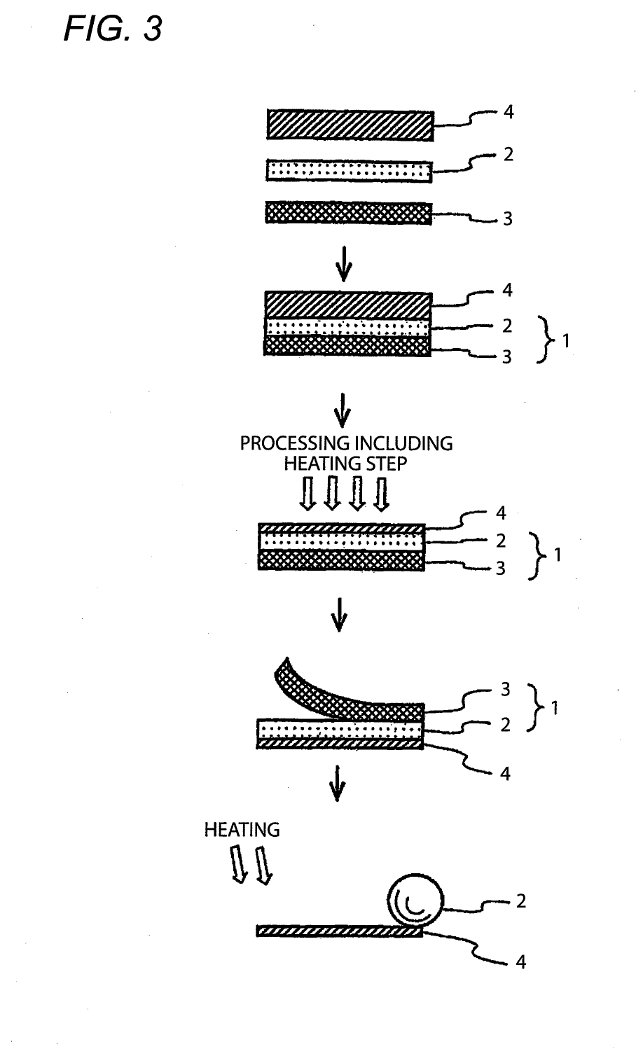

FIG. 3 is a schematic process drawing (sectional view) showing an example of the adherend processing method of the invention, which includes the following respective steps.

1. The removable pressure sensitive adhesive sheet 1 of the invention (self-rolling pressure sensitive adhesive sheet 2 and pressure sensitive adhesive sheet layer 3) is stuck to a semiconductor wafer or the like adherend 4.

2. A certain processing including a heating step (grinding treatment or the like) is applied to the adherend 4 to which the removable pressure sensitive adhesive sheet 1 has been attached.

3. Pressure sensitive adhesive tape 3 is peeled off.

4. Self-rolling pressure sensitive adhesive sheet 2 is allowed to undergo self-rolling-separation by adding a heat stimulus (or peeled off by pulling the self-rolling pressure sensitive adhesive sheet 2 from its edge part floated up from the adherend 4).

As the adherend, for example, a semiconductor wafer which uses silicon, gallium-arsenic and the like as the material, a semiconductor package, glass, ceramics and the like can be cited. Included in the kind of adherend processing are, for example, grinding, cutting, polishing, spattering, etching, lathe processing, heating and the like. In the invention, the removable pressure sensitive adhesive sheet 1 prepared by laminating the pressure sensitive adhesive sheet layer 3 on the self-rolling pressure sensitive adhesive sheet 2 which spontaneously peels off by heating is used as a pressure sensitive adhesive sheet for tentative fixing use and the like, so that the self-rolling pressure sensitive adhesive sheet 2 is not peeled off from the surface of an adherend 4 even when a processing including a heating step (e.g., a processing including a heating step at a temperature of 80° C. or more) is applied to the adherend 4. Accordingly, even when the processing including a heating step is applied to an adherend 4, generation of a “crack” or “chip” on the adherend 4 can be prevented. In addition, after applying a certain processing to the adherend 4, the removable pressure sensitive adhesive sheet 2 of the invention is peeled off and recovered from the adherend 4 by the addition of a heat stimulus.

Regarding the method for attaching the removable pressure sensitive adhesive sheet 1 onto the surface of the adherend 4, as described in the foregoing, the self-rolling pressure sensitive adhesive sheet 2 may be firstly attached to the surface of the adherend 4, followed by lamination of the pressure sensitive adhesive sheet layer 3 on the self-rolling pressure sensitive adhesive sheet 2, or the removable pressure sensitive adhesive sheet 1 prepared in advance by laminating the self-rolling pressure sensitive adhesive sheet 2 with the pressure sensitive adhesive sheet 3 may be attached to the surface of the adherend 4.

According to the invention, the method including attaching the self-rolling pressure sensitive adhesive sheet 2 to the surface of the adherend 4 and then laminating the pressure sensitive adhesive sheet layer 3 on the self-rolling pressure sensitive adhesive sheet 2 is desirable from the viewpoint of workability and the like. In addition, it is particularly desirable to laminate and attach the pressure sensitive adhesive sheet layer 3 on the self-rolling pressure sensitive adhesive sheet 2, in such a state that it is stretching out in longitudinal direction from an edge part of the self-rolling pressure sensitive adhesive sheet 2. By laminating in the state of stretching out from the edge part, the stretched part can be used as a chance of separation.

Also, at the time of peeling off the pressure sensitive adhesive sheet layer 3, it is desirable to peel off the pressure sensitive adhesive sheet layer 3 under such a condition that the adhesive strength of the pressure sensitive adhesive sheet layer 3 with respect to the heat contractible film layer 21 is smaller than the adhesive strength of the self-rolling pressure sensitive adhesive sheet 2 with respect to the adherend 4. When the adhesive strength of the pressure sensitive adhesive sheet layer 3 with respect to the heat contractible film layer 21 exceeds the adhesive strength of the self-rolling pressure sensitive adhesive sheet 2 with respect to the adherend 4, the self-rolling pressure sensitive adhesive sheet 2 is also peeled off from the adherend 4 in peeling off the pressure sensitive adhesive sheet layer 3, so that there is a case in which the brittle adherend is damaged by the separation stress.

Further, after completion of the processing of the adherend 4, it is desirable to cool down to a temperature lower than the temperature at which deformation of the self-rolling pressure sensitive adhesive sheet 2 is induced (e.g., 70° C. or lower, preferably 50° C. or lower), by carrying out a cooling treatment before separation of the pressure sensitive adhesive sheet layer 3. When the cooling treatment is carried out, a possibility of causing rolling-separation of the self-rolling pressure sensitive adhesive sheet 2 in peeling off the pressure sensitive adhesive sheet layer 3 can be reduced and a possibility of causing damage of the brittle adherend can be minimized. As the cooling treatment method, for example, spontaneous cooling, ventilation and the like can be cited.

In addition, when an active energy ray curing type pressure sensitive adhesive layer is used as the second pressure sensitive adhesive layer 32, first pressure sensitive adhesive layer 24 or elastic layer 22, the active energy ray curing type pressure sensitive adhesive layer is cured by irradiating an active energy ray at an appropriate time of for example before separation of the pressure sensitive adhesive sheet layer 3. Adhesive strength of the pressure sensitive adhesive sheet layer 3 with respect to the self-rolling pressure sensitive adhesive sheet 2 can be lowered by curing the second pressure sensitive adhesive layer 32, adhesive strength of the self-rolling pressure sensitive adhesive sheet 2 with respect to a semiconductor wafer or the like adherend 4 can be lowered by curing the first pressure sensitive adhesive layer 24, and the self-rolling-separation (or formation of floating of an edge part) of the self-rolling pressure sensitive adhesive sheet 2 by the provision of heat, which is subsequently carried out, can be induced more efficiently by curing the elastic layer 22.

As the active energy ray exposure means, it is not particularly limited, and in the case of ultraviolet ray irradiation for example, an ultraviolet ray exposure device which uses a high pressure mercury lamp, a medium pressure mercury lamp, a low pressure mercury lamp or the like light source that efficiently forms ultraviolet ray can be used. Irradiation intensity, irradiation time and the like irradiation conditions in carrying out the active energy ray irradiation are not particularly limited and can be optionally set in response to the necessity, and in the case of the use of ultraviolet ray as the active energy ray for example, they are approximately from 50 to 2,000 mJ/cm² and from 1 to 180 second irradiation.

Regarding the method for separating the pressure sensitive adhesive sheet layer 3, for example, it can be easily recovered by sticking a release tape to the surface of the pressure sensitive adhesive sheet layer 3 and pulling the stuck release tape upward.

In this connection, as described in the foregoing, when a release layer is arranged on the surface of the second rigid film layer 31, the second rigid film layer 31 may be separated instead of separating the pressure sensitive adhesive sheet layer 3.

After separation of the pressure sensitive adhesive sheet layer 3 from the self-rolling pressure sensitive adhesive sheet 2 (or after separation of the second rigid film layer 31), a peripheral region of the self-rolling pressure sensitive adhesive sheet 2 is deformed by heating an edge part in contraction direction of the self-rolling pressure sensitive adhesive sheet 2 when a mono-axially contractible film is used as a heat contractible film, or by heating from an optional one direction of the self-rolling pressure sensitive adhesive sheet 2 when a bi-axially contractible film is used, thereby effecting generation of a floating from the adherend 4, and then its self-rolling-separation can be effected. Heating temperature and heating time of the self-rolling pressure sensitive adhesive sheet 2 can be optionally adjusted in response to the heat contractibility of the heat contractible film to be used, and the heating temperature is for example from 70 to 180° C., preferably from 70 to 140° C. The heating time is approximately for example from 5 to 180 seconds.

In this connection, the condition of the floating generated between a peripheral region of the self-rolling pressure sensitive adhesive sheet 2 and the adherend 4 can be held up as such by adjusting the heating. In that case, the self-rolling pressure sensitive adhesive sheet 2 can be easily recovered by sticking a release tape thereto, using the floated part of peripheral region of the self-rolling pressure sensitive adhesive sheet 2 as a separating chance, and pulling the stuck release tape upward.

According to the invention, separation stress on an adherend can be lessoned as small as possible because of the use of the self-rolling pressure sensitive adhesive sheet, so that damage and adhesive transfer and the like pollution of the adherend can be prevented even when the adherend is brittle.

### EXAMPLES

The following describes the invention further in detail based on examples, though the invention is not limited by these examples.

### Production Example 1

### Preparation of Self-Rolling Pressure Sensitive Adhesive Sheet

An ester system polymer mixed liquid composed of 100 parts by weight of an ester system polymer (a polymer obtained from 100 parts by weight of “PLACCEL CD220PL” mfd. by Daicel Chemical Industries and 10 parts by weight of sebacic acid) and 4 parts by weight of a crosslinking agent (trade name “CORONATE L” mfd. by NIPPON POLYURETHANE INDUSTRY) was applied to one side of a polyethylene terephthalate film (PET film, thickness 38 μm, trade name “Lumirror S 10” mfd. by TORAY INDUSTRIES) to be used as a rigid film layer, and a heat contractible film (mono-axially stretched polyester film, thickness 30 μm: trade name “SPACECLEAN S5630” mfd. by TOYOBO) was put thereupon and laminated using a hand roller to obtain a three-layer laminate sheet [thickness of an ester system pressure sensitive adhesive layer (elastic layer) 30 μm].

Next, a non-energy ray curing type pressure sensitive adhesive (pressure sensitive type pressure sensitive adhesive) A was prepared by mixing 100 parts by weight of an acrylic system copolymer A [obtained by copolymerizing butyl acrylate:acrylic acid=100:3 (weight ratio)] with 0.7 part by weight of a crosslinking agent (trade name “TETRAD-C” mfd. by Mitsubishi Gas Chemical Company) and 2 parts by weight of a crosslinking agent (trade name “CORONATE L”).

The thus obtained non-energy ray curing type pressure sensitive adhesive A was coated on a release sheet (trade name “MRF 38” mfd. by Mitsubishi Polyester Film) using an applicator, and then solvents and the like volatile matters were dried, thereby obtaining a layered product in which a non-energy ray curing type pressure sensitive adhesive layer of 30 μm in thickness was arranged on the release sheet.

By laminating this layered product on the polyethylene terephthalate film side of the above-mentioned three-layer laminate sheet, a self-rolling pressure sensitive adhesive sheet having a layer constitution of heat contractible film layer/elastic layer/rigid film layer/pressure sensitive adhesive layer/release sheet was obtained.

### Production Example 2

### Preparation of Pressure Sensitive Adhesive Sheet (1)

A non-energy ray curing type pressure sensitive adhesive (pressure sensitive type pressure sensitive adhesive) B was prepared by mixing 100 parts by weight of an acrylic system copolymer B [obtained by copolymerizing butyl acrylate:ethyl acrylate:acrylic acid:2-hydroxyethyl acrylate=50:50:5:0.1 (weight ratio)] with 4 parts by weight of a crosslinking agent (trade name “TETRAD-C” mfd. by Mitsubishi Gas Chemical Company) and 1.5 parts by weight of a crosslinking agent (trade name “CORONATE L”).

The thus obtained non-energy ray curing type pressure sensitive adhesive B was coated on one side of a polyethylene terephthalate film (PET film, thickness 25 trade name “Lumirror S 10” mfd. by Toray Industries) using an applicator, and then solvents and the like volatile matters were dried, thereby obtaining a pressure sensitive adhesive sheet (1) in which a non-energy ray curing type pressure sensitive adhesive layer of 30 μm in thickness was arranged on a base material film (rigid film layer).

### Production Example 3

### Preparation of Pressure Sensitive Adhesive Sheet (2)

An acrylic system copolymer C having methacrylate group on its side chain was prepared by allowing 80% of 2-hydroxyethyl acrylate-derived hydroxyl groups of an acrylic system copolymer [obtained by copolymerizing butyl acrylate:ethyl acrylate:2-hydroxyethyl acrylate=50:50:20 (weight ratio)] to combine with methacryloyloxyethyl isocyanate (ethyl 2-isocyanate methacrylate).

An energy ray curing type pressure sensitive adhesive C was prepared by mixing 100 parts by weight of this acrylic system copolymer C having methacrylate group on its side chain with 3 parts by weight of a photo-initiator (trade name “IRGACURE” mfd. by Ciba Specialty Chemicals) and 0.2 part by weight of a crosslinking agent (trade name “CORONATE L”).

The thus obtained energy ray curing type pressure sensitive adhesive C was coated on one side of a polyethylene terephthalate film (PET film, thickness 50 μm: trade name “Lumirror S 10” mfd. by Toray Industries) using an applicator, and then solvents and the like volatile matters were dried, thereby obtaining a pressure sensitive adhesive sheet (2) in which a energy ray curing type pressure sensitive adhesive layer of 30 μm in thickness was arranged on a base material film (rigid film layer).

### Production Example 4

### Preparation of Pressure Sensitive Adhesive Sheet (3)

A non-energy ray curing type pressure sensitive adhesive (pressure sensitive type pressure sensitive adhesive) D was prepared by mixing 100 parts by weight of an acrylic system copolymer B [obtained by copolymerizing butyl acrylate:ethyl acrylate:acrylic acid:2-hydroxyethyl acrylate=50:50:5:0.1 (weight ratio)] with 0.07 part by weight of a crosslinking agent (trade name “TETRAD-C” mfd. by Mitsubishi Gas Chemical Company).

The thus obtained non-energy ray curing type pressure sensitive adhesive D was coated on one side of a polyethylene terephthalate film (PET film, thickness 50 μm: trade name “Lumirror S 10” mfd. by Toray Industries) using an applicator, and then solvents and the like volatile matters were dried, thereby obtaining a pressure sensitive adhesive sheet (3) in which a non-energy ray curing type pressure sensitive adhesive layer of 30 μm in thickness was arranged on a base material film (rigid film layer).

### Production Example 5

### Preparation of Pressure Sensitive Adhesive Sheet (4)

An ethylene-ethyl acrylate copolymer (EEA resin, trade name “AR-210” mfd. by Mitsui Du Pont Polychemical) was dissolved in toluene, coated on a release sheet (trade name “MRF 38” mfd. by Mitsubishi Polyester Film) and then dried to obtain an EEA sheet of 80 μm in thickness.

Next, the non-energy ray curing type pressure sensitive adhesive (pressure sensitive type pressure sensitive adhesive) B prepared in the same manner as in Production Example 2 was applied to this release sheet and dried to form a non-energy ray curing type pressure sensitive adhesive layer of 30 μm in thickness. This was transferred on the above-mentioned EEA sheet, thereby obtaining a pressure sensitive adhesive sheet (4) in which the non-energy ray curing type pressure sensitive adhesive layer of 30 μm in thickness was arranged on a base material film.

### Inventive Example 1

The self-rolling pressure sensitive adhesive sheet obtained in Production Example 1 was stuck to a 4 inch orientation flat wafer and then the above-mentioned pressure sensitive adhesive sheet (1) precut to 4 inch φ (diameter) in advance was stuck thereto, thereby obtaining a layered product (1) having a layer construction of wafer/self-rolling pressure sensitive adhesive sheet/pressure sensitive adhesive sheet (1).

### Inventive Example 2

The self-rolling pressure sensitive adhesive sheet obtained in Production Example 1 was stuck to a 4 inch orientation flat wafer and then the above-mentioned pressure sensitive adhesive sheet (2) precut to 4 inch φ (diameter) in advance was stuck thereto, thereby obtaining a layered product (1) having a layer construction of wafer/self-rolling pressure sensitive adhesive sheet/pressure sensitive adhesive sheet (2).

### Comparative Example 1

The self-rolling pressure sensitive adhesive sheet obtained in Production Example 1 was stuck to a 4 inch orientation flat wafer, thereby obtaining a layered product (3) having a layer construction of wafer/self-rolling pressure sensitive adhesive sheet.

### Comparative Example 2

The self-rolling pressure sensitive adhesive sheet obtained in Production Example 1 was stuck to a 4 inch orientation flat wafer and then the above-mentioned pressure sensitive adhesive sheet (3) precut to 4 inch φ (diameter) in advance was stuck thereto, thereby obtaining a layered product (4) having a layer construction of wafer/self-rolling pressure sensitive adhesive sheet/pressure sensitive adhesive sheet (3).

### Comparative Example 3

The self-rolling pressure sensitive adhesive sheet obtained in Production Example 1 was stuck to a 4 inch orientation flat wafer and then the above-mentioned pressure sensitive adhesive sheet (4) precut to 4 inch φ (diameter) in advance was stuck thereto, thereby obtaining a layered product (5) having a layer construction of wafer/self-rolling pressure sensitive adhesive sheet/pressure sensitive adhesive sheet (4).

Evaluation Tests

The following evaluation tests were carried out on the respective layered products, and their constituting members, obtained in the inventive examples and comparative examples. The results are shown in Table 1. In the table, “−” means that no test was carried out.

Adhesive strength of self-rolling pressure sensitive adhesive sheet with respect to silicon wafer

The self-rolling pressure sensitive adhesive sheet obtained in Production Example 1 was cut off to a width of 10 mm and, after removing the release sheet (separator), stuck to a 4 inch silicon mirror wafer (trade name “CZ-N” mfd. by Shin-Etsu Handotai) using a hand roller. A tensile jig of a peel separation tester was stuck thereto using a pressure sensitive adhesive tape. The tensile jig was pulled toward the 180° direction at a tensile rate of 300 mm/min, and the force (N/10 mm) when separation was generated between the silicon wafer and the non-energy ray curing type pressure sensitive adhesive layer was measured.

Young's Modulus (80° C.) of Base Material Film of Pressure Sensitive Adhesive Sheet

Young's modulus of base material films of the pressure sensitive adhesive sheets (1) to (4) obtained in Production Examples 2 to 5 was measured by the following method in accordance with JIS K 7127. As the tensile tester, Autograph AG-1kNG (equipped with a heating hood) manufactured by Shimadzu Corp. was used. A base material film cut out into 200 mm in length×10 mm in width was installed at an inter-chuck distance of 100 mm. After setting the atmosphere to 80° C. by the heating hood, each sample was pulled at a tensile rate of 5 mm/min, thereby obtaining a measured value of stress-distortion correlation. Young's modulus was obtained by calculating the load on two points of distortion, 0.2% and 0.45%. This measurement was repeated 5 times on the same sample and their average value was employed (measured on the TD direction and MD direction of the base material film). In this connection, regarding the Young's modulus of the base material film of the pressure sensitive adhesive sheet (4) (Production Example 5) used in Comparative Example 3, shear modulus G was measured in the same manner as in the following method for measuring shear modulus of pressure sensitive adhesive layer of pressure sensitive adhesive sheet, and then Young's modulus E′ was calculated by a relational expression E′=3×G.

Shear Modulus (80° C.) of Pressure Sensitive Adhesive Layer of Pressure Sensitive Adhesive Sheet

Shear modulus of pressure sensitive adhesive layers of the pressure sensitive adhesive sheets (1) to (4) obtained in Production Examples 2 to 5 was measured by the following method. Each pressure sensitive adhesive layer was prepared with a thickness of from 1.5 mm to 2 mm, and then this was stamped out using a punch of 7.9 mm in diameter to obtain a sample for measurement. Using a visco-elasticity spectrometer (ARES) manufactured by Rheometric Scientific, the measurement was carried out by setting the chuck pressure to 100 g in weight and the shear to a frequency of 1 Hz [an 8 mm parallel plate made of stainless steel (mfd. by T A Instruments, type 708.0157) was used]. Shear modulus at 80° C. was used.

Adhesive Strength of Pressure Sensitive Adhesive Sheet with Respect to Self-Rolling Pressure Sensitive Adhesive Sheet

Each sample was prepared by sticking the self-rolling pressure sensitive adhesive sheet obtained in Production Example 1 to a silicon wafer, and further sticking each of the pressure sensitive adhesive sheets (1) to (4) used in Inventive Examples 1 and 2 and Comparative Examples 2 and 3 (those which were cut into a size of 10 mm in width) to the heat contractible film layer side surface of the self-rolling pressure sensitive adhesive sheet. Using a tensile jig of a peel separation tester, said pressure sensitive adhesive sheet was pulled toward the 180° direction at a tensile rate of 300 mm/min, and the force (N/10 mm) when separation was generated between the pressure sensitive adhesive layer of pressure sensitive adhesive sheet and the heat contractible film layer of self-rolling pressure sensitive adhesive sheet was measured.

In this connection, regarding Inventive Example 2 (a case of using pressure sensitive adhesive sheet (2)), adhesive strength of the pressure sensitive adhesive sheet after irradiation of ultraviolet ray for the self-rolling pressure sensitive adhesive sheet was also measured. This adhesive strength was measured in the same manner as described in the above, but after carrying out the heat resistance test described in the following and subsequently irradiating ultraviolet lay (cumulative quantity of light 300 mJ/cm²) from the backside of the pressure sensitive adhesive sheet.

Heat Resistance Test

Each sample was prepared by peeling off the release sheet (separator) from the self-rolling pressure sensitive adhesive sheet obtained in Production Example 1, sticking the resulting sheet to a 4 inch silicon mirror wafer, further sticking each of the pressure sensitive adhesive sheets (1) to (4) used in Inventive Examples 1 and 2 and Comparative Examples 2 and 3 to the heat contractible film layer side surface of the self-rolling pressure sensitive adhesive sheet, and then cutting off the protruding sheet along the wafer peripheral (pressure sensitive adhesive sheet is not laminated on the self-rolling pressure sensitive adhesive sheet in the case of Comparative Example 1). By applying 30 minutes of heat treatment at 100° C. to the aforementioned samples, whether or not the self-rolling pressure sensitive adhesive sheet was peeled off from the silicon mirror wafer surface was observed with the naked eye.

Peeling Test of Pressure Sensitive Adhesive Sheet

After the above-mentioned heat resistance test, a release tape (trade name “BT-315”, mfd. by Nitto Electric Industrial, 30 mm in width) was stuck to the backside of the pressure sensitive adhesive sheet, said release tape was pulled toward the 180° direction at a tensile rate of 300 mm/min, and whether or not separation was generated between the pressure sensitive adhesive layer of pressure sensitive adhesive sheet and the heat contractible film layer of self-rolling pressure sensitive adhesive sheet was observed. The case of generating separation was regarded as “yes”, and the case of not generating separation as “no”. In this connection, regarding Inventive Example 2 (a case of using pressure sensitive adhesive sheet (2)), the test was carried out in the same manner as described in the above, but after carrying out the above-mentioned heat resistance test and subsequently irradiating ultraviolet lay (cumulative quantity of light 300 mJ/cm²) from the backside of the pressure sensitive adhesive sheet.

Peeling Test of Self-Rolling Pressure Sensitive Adhesive Sheet

After carrying out the above-mentioned peeling test of pressure sensitive adhesive sheet (after peeling of pressure sensitive adhesive sheet), a longitudinal direction edge part of the self-rolling pressure sensitive adhesive sheet of each sample was heated to 80° C. using a dryer, and whether or not it performs self-rolling separation was observed. The case of generating self-rolling separation was regarded as “yes”, and the case of not generating self-rolling separation as “no”.

TABLE 1

| | | Inv. | Inv. | Comp. | Comp. | Comp. |
|---|---|---|---|---|---|---|
| | | Ex. 1 | Ex. 2 | Ex. 1 | Ex. 2 | Ex. 3 |
| Kind of pressure sensitive adhesive sheet | | (1) | (2) | None | (3) | (4) |
| Adhesive strength of self-rolling pressure sensitive adhesive sheet with | | 0.65 | 0.65 | 0.65 | 0.65 | 0.65 |
| respect to silicon wafer (ordinary state) (N/10 mm) | | | | | | |
| Young's modulus of base material film of pressure sensitive adhesive sheet | | TD: 3500 | TD: 3500 | — | TD: 3500 | 0.42 |
| (MPa; 80° C.) | | MD: 3300 | MD: 3300 | | MD: 3300 | |
| Shear modulus of pressure sensitive adhesive layer of pressure sensitive | | 0.6 | 0.05 | — | 0.01 | 0.6 |
| adhesive sheet (MPa; 80° C.) | | | | | | |
| Adhesive strength of pressure sensitive adhesive sheet with | Ordinary state | 0.11 | 6.55 | — | 8.82 | 0.31 |
| respect to self-rolling pressure sensitive adhesive sheet | After UV | — | 0.01 or | — | — | — |
| (N/10 mm) | irradiation | | less | | | |

| | | | | | |
|---|---|---|---|---|---|
| Heat resistance test (100° C. × 30 min) | no | no | peeling | peeling | peeling |
| | peeling | peeling | | | |
| Peeling test of pressure sensitive adhesive sheet (after heat resistance test) | yes | yes | — | — | — |
| Peeling test of self-rolling pressure sensitive adhesive sheet (80° C.) | yes | yes | yes | — | — |

While the present invention has been described in detail and with reference to specific embodiments thereof, it will be apparent to one skilled in the art that various changes and modifications can be made therein without departing from the scope thereof.

This application is based on Japanese patent application No. 2009-092664 filed Apr. 7, 2009, the entire contents thereof being hereby incorporated by reference.

What is claimed is:

1. A removable pressure sensitive adhesive sheet, which comprises:
a self-rolling pressure sensitive adhesive sheet which is capable of spontaneously rolling up by a thermal stimulation, the self-rolling pressure sensitive adhesive sheet comprising a first pressure sensitive adhesive layer, a first rigid film layer, an elastic layer and a heat contractible film layer laminated in this order; and
a second pressure sensitive adhesive layer and a second rigid film layer laminated in this order on the heat contractible film layer side of the self-rolling pressure sensitive adhesive sheet,
wherein the second pressure sensitive adhesive layer is removable from the heat contractible film layer or the second rigid film layer is removable from the second pressure sensitive adhesive layer.

2. The removable pressure sensitive adhesive sheet according to claim 1, wherein a pressure sensitive adhesive sheet including a base material is used as the second pressure sensitive adhesive layer and the second rigid film layer to be laminated on the heat contractible film layer side of the self-rolling pressure sensitive adhesive sheet.

3. The removable pressure sensitive adhesive sheet according to claim 1, wherein the second rigid film layer has a Young's modulus at 80° C. of from 1×10⁶ to 2×10¹⁰ Pa.

4. The removable pressure sensitive adhesive sheet according to claim 1, wherein the second pressure sensitive adhesive layer has a shear modulus at 80° C. of 4×10⁴ Pa or more.

5. A method for processing an adherend, which comprises steps of:
applying a certain processing to an adherend to which the removable pressure sensitive adhesive sheet according to claim 1 has been attached;
then removing (1) the second pressure sensitive adhesive layer and the second rigid film layer or (2) the second rigid film layer of the removable pressure sensitive adhesive sheet; and
subsequently effecting rolling-separation of (1) the self-rolling pressure sensitive adhesive sheet or (2) the self-rolling pressure sensitive adhesive sheet and the second pressure sensitive adhesive layer, from the adherend by a heating treatment.

6. The method for processing an adherend according to claim 5, wherein said processing step of the adherend includes a heating step conducted at 80° C. or more.
